(19) United States
(12) Patent Application Publication
(10) Pub. No.: US 2025/0363435 A1
(43) Pub. Date: Nov. 27, 2025

(54) METHODS AND SYSTEMS FOR GENERATING ADVANCED PLANNING TOOLS FOR OPERATIONS ANALYSIS AND MANAGEMENT

(71) Applicants: Timothy Tin Long YU, Vancouver (CA); Mahdi MOSTAJABDAVEH, Vancouver (CA); Rindranirina RAMAMONJISON, Vancouver (CA); Jabo Serge BYUSA, Vancouver (CA); Giuseppe CARENINI, Burnaby (CA); Kun MAO, Shenzhen (CN); Zirui ZHOU, Surrey (CA); Yong ZHANG, Richmond (CA)

(72) Inventors: Timothy Tin Long YU, Vancouver (CA); Mahdi MOSTAJABDAVEH, Vancouver (CA); Rindranirina RAMAMONJISON, Vancouver (CA); Jabo Serge BYUSA, Vancouver (CA); Giuseppe CARENINI, Burnaby (CA); Kun MAO, Shenzhen (CN); Zirui ZHOU, Surrey (CA); Yong ZHANG, Richmond (CA)

(21) Appl. No.: 18/672,912

(22) Filed: May 23, 2024

(51) Int. Cl. G06Q 10/0633

(52) U.S. Cl. CPC G06Q 10/0633

(57) ABSTRACT

Methods and systems for automated generation of an advanced planning tool (APT) for an advanced planning system (APS) are described. One or more input questions for an operations plan are received. A generic APT contract that is relevant to a given one input question is retrieved. The generic APT contract is customized by mapping parameters defined in the data schema associated with the operations plan to placeholders in the generic APT contract. Generic APT code corresponding to the generic APT contract is customized by replacing placeholders in the generic APT code with parameters defined in the data schema, in accordance with the mapping. The customized APT code is deployed to obtain the executable customized APT. Verification of the customized APT is performed by automatically performing test executions of the customized APT using test inputs automatically generated using the data schema. The customized APT contract is outputted to a user device.

### TECHNICAL FIELD

The present disclosure relates to methods and systems for generating advanced planning tools for an advanced planning system used in operations analysis and management.

### BACKGROUND

Many businesses require operations planning to help guide business operations towards some optimal goal (e.g., greater efficiency, greater profitability, etc.). An operations plan (also referred to simply as a “plan”) typically details the decision activity over a period of time (also referred to as the planning horizon). In practice, operations planning may be done manually by human operations planners and/or may be assisted by software referred to as advanced planning systems (APSs). Often, it is useful to perform advanced analysis of an operations plan, such as “what-if” analysis (e.g., changing data or a parameter in the operations plan and considering the outcome) or “why-not” analysis (e.g., changing the optimization model, such as by adding new constraints and considering the outcome). Such advanced analysis typically require a human support consultant to develop advanced planning tools (APTs) to provide additional functionality to the APS.

The development and implementation of APTs can be complex. Support consultants need to have good programming skills as well as operations management knowledge. Additionally, verification of an APT can be highly technical, time-consuming and not easily understood by an end user who is not a support consultant. APTs are typically highly specific to a particular business or particular domain, and cannot be easily adapted to a different business or domain.

Thus, development of APTs have so far been limited by availability of human support consultants, and the understanding of APTs by end users have been limited.

It would be useful to provide a solution that can help generate APTs with greater efficiency and improved accessibility.

### SUMMARY

In various examples, the present disclosure describes methods and systems for automated generation of APTs for operations analysis and management. An example APT generation system accepts multimodal input, including information for an existing operations plan (e.g., optimization model code, data schema object and operations plan object), and one or more questions to be answered using the generated APT(s) (e.g., in the form of a list of natural language questions). The APT generation system performs operations to generate one or more customized APTs that can be used to answer the input question(s), starting from generic APTs.

The APT generation system may automatically generate documentation for each customized APT that is generated (e.g., in the form of a customized APT contract) and may also automatically generate APT code for implementing the customized APT.

Examples of the present disclosure may enable a user who is not an expert in developing APTs to be able to generate a customized APT, without having to learn coding or having to understand how to generate an APT from scratch.

In some examples, a user interface is described that may enable a user to provide inputs to and receive outputs from the APT generation system. For example, a user interface may be in the form of a chatbot.

Examples of the present disclosure may provide a technical advantage in that a customized APT can be automatically generated, including documentation and implementation code, based on relatively simple inputs such as a list of natural language questions and an existing operations plan. The present disclosure may also provide a technical advantage in that, by providing documentation in the form of an APT contract, a user may more easily modify the APT by modifying the APT contract and the disclosed system may automatically generate a modified APT accordingly. The need for time-consuming and costly analysis by an expert may be avoided.

In an example aspect, the present disclosure describes a computing system including a processing device configured to execute computer-readable instructions to cause the system to: receive a set of one or more input questions for an operations plan, the operations plan being associated with a data schema and an optimization model; generate a customized advanced planning tool (APT) providing a customized function to enable an advanced planning system (APS) to address at least a given one of the one or more input questions by: retrieving, from a database, a generic APT contract defining one or more input parameters and an output schema for a generic function that is relevant to the given one input question; customizing the generic APT contract by mapping parameters defined in the data schema to placeholders in the generic APT contract to obtain a customized APT contract defining one or more customized input parameters and a customized output schema for the customized APT; obtain generic APT code corresponding to the generic APT contract, the generic APT code providing an implementation of the generic function; customizing the generic APT code by replacing placeholders in the generic APT code with parameters defined in the data schema, in accordance with the mapping, to obtain customized APT code providing the customized function of the customized APT, and deploying the customized APT code to obtain the executable customized APT; and performing verification of the customized APT by automatically performing test executions of the customized APT using one or more test inputs automatically generated using the data schema. The system is further caused to output the customized APT contract to a user device and store the executable customized APT.

In an example of the preceding example aspect of the system, the processing device may be configured to execute computer-readable instructions to cause the system to: receive, from the user device, natural language input providing the set of one or more input questions, code representing the optimization model and a data object representing the data schema.

In an example of any of the preceding example aspects of the system, the processing device may be configured to execute computer-readable instructions to cause the system to retrieve the generic APT contract by: obtaining a question embedding encoded from the given one input question; and retrieving, from the database, the generic APT contract corresponding to a contract embedding that is similar to the question embedding.

In an example of any of the preceding example aspects of the system, the processing device may be configured to execute computer-readable instructions to cause the system to: generate a first customized APT contract to address a first question of the one or more input questions; generate a second customized APT contract to address a second question of the one or more input questions, the first and second customized APT contracts being based on a common generic APT contract; prior to obtaining customized APT code based on the first or second customized APT contracts, determine that the first and second customized APT contracts have identical mapping between parameters in the data schema and placeholders in the common generic APT contract; and discard one of the first or second customized APT contracts, wherein customized APT code is only obtained for a remaining one of the first or second customized APT contracts.

In an example of any of the preceding example aspects of the system, the processing device may be configured to execute computer-readable instructions to cause the system to customize the generic APT code by: generating a code snippet to replace a placeholder code section in the generic APT code.

In an example of the preceding example aspect of the system, the processing device may be configured to execute computer-readable instructions to cause the system to generate the code snippet by: generating a prompt to a large language model (LLM) to perform a code generation task, the prompt including code representing the optimization model, the operations plan, the customized APT contract and at least a portion of the generic APT code including the placeholder code section; and obtaining the generated code snippet as output from the LLM.

In an example of the preceding example aspect of the system, the processing device may be configured to execute computer-readable instructions to cause the system to: receive an error during a particular test execution of the customized APT; and re-generate at the code snippet using information from the received error.

In an example of any of the preceding example aspects of the system, the processing device may be configured to execute computer-readable instructions to cause the system to perform verification of the customized APT by: automatically generating the one or more test inputs, wherein the one or more test inputs include all possible values for a discrete input parameter defined in the data schema or include sample values within a numerical range defined for a numerical input parameter in the data schema.

In an example of any of the preceding example aspects of the system, the processing device may be configured to execute computer-readable instructions to cause the system to perform verification of the customized APT by: collecting one or more outputs generated by the test executions of the customized APT; and performing sensitivity analysis on the collected one or more outputs.

In an example of any of the preceding example aspects of the system, the processing device may be configured to execute computer-readable instructions to cause the system to: include the one or more test inputs and corresponding outputs generated by the test executions of the customized APT in the customized APT contract.

In an example of any of the preceding example aspects of the system, the processing device may be configured to execute computer-readable instructions to cause the system to: receive, from the user device, input revising the customized APT contract; wherein the customized APT code is obtained in accordance with the revised customized APT contract.

In another example aspect, the present disclosure describes a method for generating a customized advanced planning tool (APT) for an advanced planning system (APS), the method including: receiving a set of one or more input questions for an operations plan, the operations plan being associated with a data schema and an optimization model; generating the customized APT providing a customized function to address at least a given one of the one or more input questions by: retrieving, from a database, a generic APT contract defining one or more input parameters and an output schema for a generic function that is relevant to the given one input question; customizing the generic APT contract by mapping parameters defined in the data schema to placeholders in the generic APT contract to obtain a customized APT contract defining one or more customized input parameters and a customized output schema for the customized APT; obtain generic APT code corresponding to the generic APT contract, the generic APT code providing an implementation of the generic function; customizing the generic APT code by replacing placeholders in the generic APT code with parameters defined in the data schema, in accordance with the mapping, to obtain customized APT code providing the customized function of the customized APT, and deploying the customized APT code to obtain the executable customized APT; and performing verification of the customized APT by automatically performing test executions of the customized APT using one or more test inputs automatically generated using the data schema. The method further includes: outputting the customized APT contract to a user device and storing the executable customized APT.

In an example of the preceding example aspect of the method, retrieving the generic APT contract may include: obtaining a question embedding encoded from the given one input question; and retrieving, from the database, the generic APT contract corresponding to a contract embedding that is similar to the question embedding.

In an example of any of the preceding example aspects of the method, the method may include: generating a first customized APT contract to address a first question of the one or more input questions; generating a second customized APT contract to address a second question of the one or more input questions, the first and second customized APT contracts being based on a common generic APT contract; prior to obtaining customized APT code based on the first or second customized APT contracts, determining that the first and second customized APT contracts have identical mapping between parameters in the data schema and placeholders in the common generic APT contract; and discarding one of the first or second customized APT contracts, wherein customized APT code is only obtained for a remaining one of the first or second customized APT contracts.

In an example of any of the preceding example aspects of the method, customizing the generic APT code may include: generating a code snippet to replace a placeholder code section in the generic APT code by: generating a prompt to a large language model (LLM) to perform a code generation task, the prompt including code representing the optimization model, the operations plan, the customized APT contract and at least a portion of the generic APT code including the placeholder code section; and obtaining the generated code snippet as output from the LLM.

In an example of any of the preceding example aspects of the method, performing verification of the customized APT may include: automatically generating the one or more test inputs, wherein the one or more test inputs include all possible values for a discrete input parameter defined in the data schema or include sample values within a numerical range defined for a numerical input parameter in the data schema.

In an example of any of the preceding example aspects of the method, performing verification of the customized APT may include: collecting one or more outputs generated by the test executions of the customized APT; and performing sensitivity analysis on the collected one or more outputs.

In an example of any of the preceding example aspects of the method, the method may include: including the one or more test inputs and corresponding outputs generated by the test executions of the customized APT in the customized APT contract.

In an example of any of the preceding example aspects of the method, the method may include: receiving, from the user device, input revising the customized APT contract; wherein the customized APT code is obtained in accordance with the revised customized APT contract.

In another example aspect, the present disclosure describes a non-transitory computer-readable medium having instructions stored thereon, wherein the instructions are executable by a processing device of a computing system to cause the computing system to: receive a set of one or more input questions for an operations plan, the operations plan being associated with a data schema and an optimization model; generate a customized advanced planning tool (APT) providing a customized function to enable an advanced planning system (APS) to address at least a given one of the one or more input questions by: retrieving, from a database, a generic APT contract defining one or more input parameters and an output schema for a generic function that is relevant to the given one input question; customizing the generic APT contract by mapping parameters defined in the data schema to placeholders in the generic APT contract to obtain a customized APT contract defining one or more customized input parameters and a customized output schema for the customized APT; obtain generic APT code corresponding to the generic APT contract, the generic APT code providing an implementation of the generic function; customizing the generic APT code by replacing placeholders in the generic APT code with parameters defined in the data schema, in accordance with the mapping, to obtain customized APT code providing the customized function of the customized APT, and deploying the customized APT code to obtain the executable customized APT; and performing verification of the customized APT by automatically performing test executions of the customized APT using one or more test inputs automatically generated using the data schema. The system is further caused to: output the customized APT contract to a user device and store the executable customized APT.

In some examples of the preceding example aspect of the computer readable medium, the instructions, when executed, may cause the computing system to implement any of the preceding example aspects of the computing system or method.

### BRIEF DESCRIPTION OF THE DRAWINGS

Reference will now be made, by way of example, to the accompanying drawings which show example embodiments of the present application, and in which:

FIG. 1A is a block diagram of an example APT generation system, in accordance with examples of the present disclosure;

FIG. 1B illustrates an example set of inputs that may be provided to the APT generation system of FIG. 1A, in accordance with examples of the present disclosure;

FIG. 1C illustrates an example customized APT contract that may be generated by the APT generation system of FIG. 1A, in accordance with examples of the present disclosure;

FIG. 2 is a block diagram of an example computing system that may be used to implement examples of the present disclosure;

FIG. 3A is a block diagram illustrating components of an example APT contract generator, which may be used in the APT generation system of FIG. 1A, in accordance with examples of the present disclosure;

FIG. 3B illustrates generic APT contract, which may be retrieved by the APT contract generator of FIG. 3A, in accordance with examples of the present disclosure;

FIG. 3C illustrates an example customized APT contract, which may be generated by the APT contract generator of FIG. 3A, in accordance with examples of the present disclosure;

FIG. 4 is a block diagram illustrating components of an example APT implementor, which may be used in the APT generation system of FIG. 1A, in accordance with examples of the present disclosure;

FIG. 5 is a block diagram illustrating components of an example APT instance verifier, which may be used in the APT generation system of FIG. 1A, in accordance with examples of the present disclosure;

FIG. 6A is a flowchart illustrating an example APT generation method, in accordance with examples of the present disclosure;

FIGS. 6B-6D are a flowcharts illustrating examples for implementing steps of the APT generation method of FIG. 6A, in accordance with examples of the present disclosure; and

FIGS. 7A-7E illustrate example user interfaces that may be provided in accordance with examples of the present disclosure.

Similar reference numerals may have been used in different figures to denote similar components.

### DETAILED DESCRIPTION

To assist in understanding the present disclosure, some background discussion regarding advanced planning systems (APSs) and adapting an APS by developing advanced planning tools (APTs) is provided.

Generally, after an operations plan is generated using an APS, the operations plan is not static. Rather, an operations plan is typically dynamic, evolving with changing circumstances. These could be changes in data (e.g., inventory updates, demand changes), new requests (e.g., different stakeholders require changes in policies which results in changes in the plan) and/or exceptions (e.g., unexpected events in supply chain and production line). APTs are typically used by an operations planner to respond to these dynamic conditions. However, the development of APTs generally is beyond the expertise of operations planners and instead is handled by system support consultants (also referred to simply as support consultants).

APTs can be developed during the APS implementation stage as well as throughout the lifetime of the APS. APTs provide additional features to the APS that may be used to manipulate components such as the optimization model, input data, and operations plan. For example, APTs may augment the APS system in a variety of ways, such as by enabling a user to explore different scenarios (e.g., what happens if a parameter or the operations plan is changed) or enabling a user to target certain metrics (e.g., what can be changed in the operations plan to reach a target profit). APTs are typically algorithms or code that may alter the model, alter the data, or call an operations research (OR) engine endpoint that allows the APT to access external algorithms or systems (e.g., an external solver) to perform complex tasks such as solving the optimization model under a scenario.

Typically, human support consultants develop and maintain these customized APTs. Support consultants not only develop the algorithm, they also implement the algorithm into code.

In some cases, there may already be one or more APTs that have been implemented, such as when the APS was first customized for the particular business operations or in response to a previous request. However, existing APTs may become outdated (e.g., due to changes in the data and/or optimization model) and may require a support consultant to update the APTs.

There are a number of challenges and drawbacks to the existing process for generating and maintaining APTs, some of which are discussed below.

One drawback is that, conventionally, the development and maintenance of APTs rely on human support consultants with specialized expertise. Support consultants need to have not only a good understanding of the functionality requested by the operations planner in order to design the APT algorithms, they also need to have the programming and operations management knowledge and skills to implement the algorithms of each APT. In addition to implementing the algorithms, support consultants also are responsible for verifying each APT's correctness and alignment to requirements of the operations planner. Support consultants are also responsible for managing the APS and supporting APTs to ensure that they are up to date with the latest state-of-the-art methods and correctly reflect any changes to the model, data, or requirements of the operations planner. This dependence on a human support consultant can be costly, time-consuming and inefficient.

The tasks of building and maintaining APTs customized to the requirements of a specific business are difficult, even for a human support consultant with expertise. Typically, APTs are advanced tools that perform functions beyond simply querying a database or comparing values between plans. Generally, APTs are complex, for example performing tasks that involve changing the model and/or data, making calls to external systems (e.g., calling a solver via OR engine endpoint), etc., which can be different across endpoints and different businesses or domains. Due to the difficulty and customization required to implement each APT for each business, this can be costly and time-consuming, and can make the adoption of APS impractical for many businesses. Further, the complex nature of APTs prevents the use of existing generation approaches to completely automate APT generation and management.

Another challenge with developing and maintaining APTs is that customized APTs are typically domain-specific, rigid, and not easily extensible to other businesses, let alone other domains. This is because each business typically would have different business strategies, requirements and entities which would need to be reflected in differences in models and data. Therefore, it often takes time to implement each APT when a support consultant is supporting different operations even if the APT has previously been implemented for another operation. Even within the same business, the APTs may need to be updated manually to reflect changes to the operation, which can occur frequently.

The process of validating and correcting an APT also tends to be inefficient. Support consultants must ensure that an APT aligns with the requirements of the business. The support consultants are also tasked with validating that the APT has been implemented correctly and that the output is an accurate response. Existing techniques for validating an APT typically involve extensive manual testing and/or review, which are labor-intensive and time-consuming.

Some attempts to improve the process of implementing APTs have been developed, such as attempts that help a user to select a suitable APT from a database of existing APTs. However, existing approaches may fail to provide full customization of APTs to a user's requirements and may fail to provide full documentation of APTs that can be understandable by a user who is not a support consultant. Existing approaches may also fail to provide a way for a non-expert user to validate or modify a generated APT. LLM-based approaches may be unable to generate APTs with sufficient accuracy and/or consistency, due to the complexity of APTs.

Examples of the present disclosure may address at least some of the above-discussed problems.

In some examples, an APT generation system is described that enables a user, who is not an expert in operations planning (e.g., not a support consultant, not an OR expert, etc.) to be able to develop and verify a customized APT, as well as to modify the APT. The APT generation system also enables the non-expert user to implement the APT by automatically generating the code for implementation. By automatically generating documentation of the customized APT, examples of the present disclosure may also enable a non-expert user to better understand the APT, and the user may modify the documentation and provide the modified documentation to the APT generation system in order to modify the APT implementation accordingly.

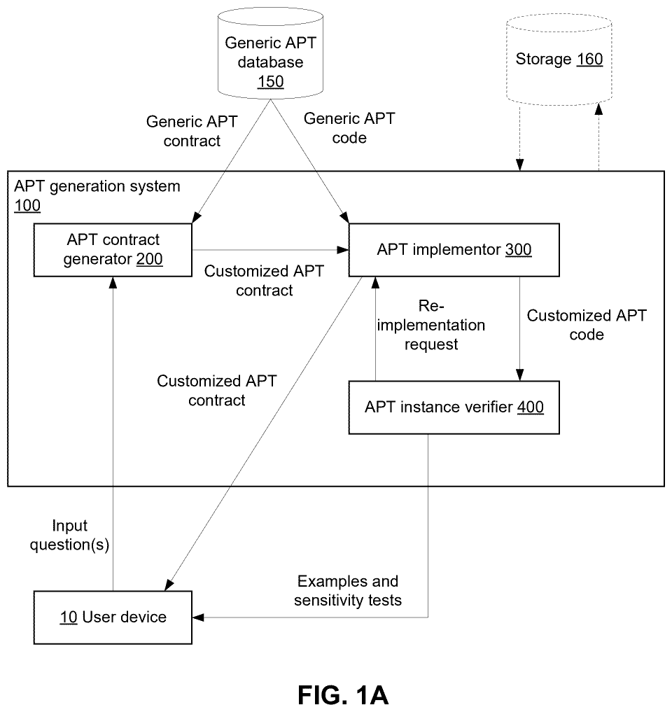

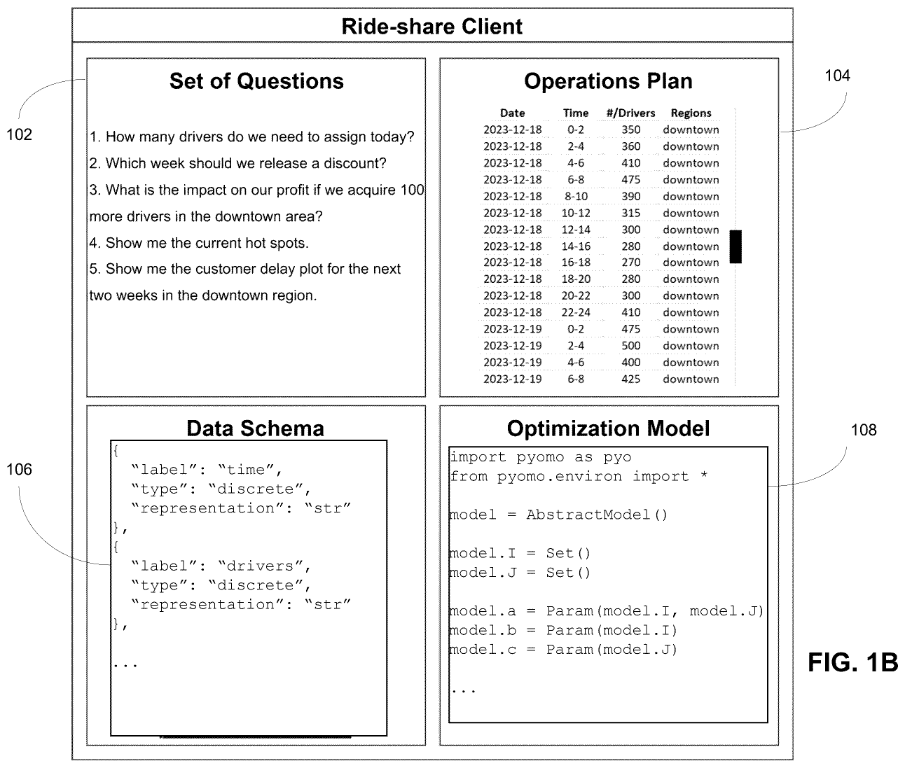

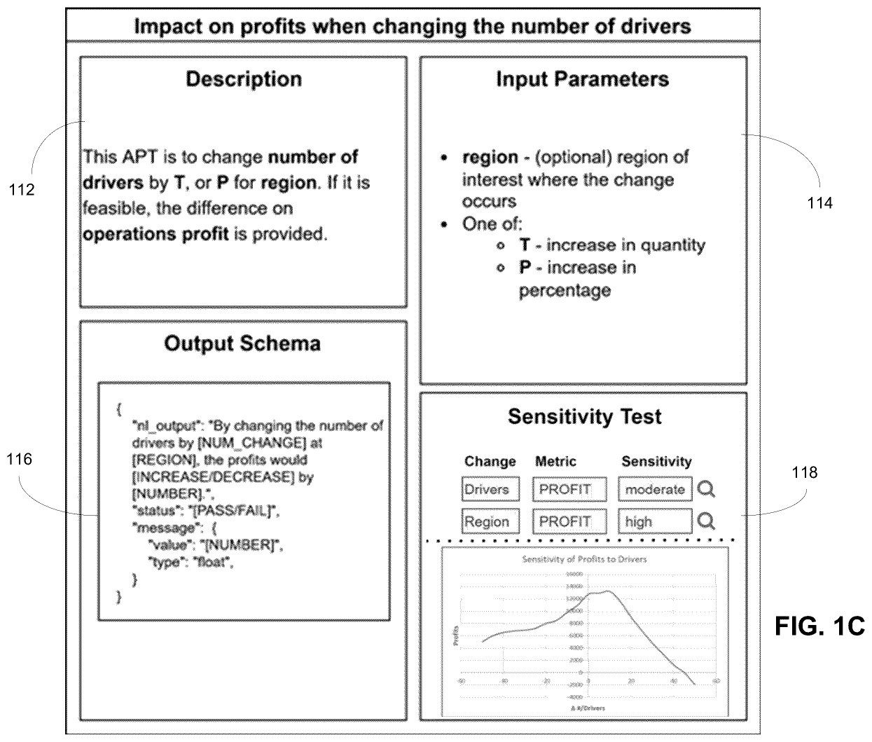

FIG. 1A is a schematic diagram illustrating an example APT generation system 100. The APT generation system 100 may be implemented in a single physical machine or device (e.g., implemented as a single computing device, such as a single workstation, single server, etc.), or may be implemented using a plurality of physical machines or devices (e.g., implemented as a server cluster). For example, the APT generation system 100 may be implemented as a virtual machine or a cloud-based service (e.g., implemented using a cloud computing platform providing a virtualized pool of computing resources). In some examples, the APT generation system 100 may provide cloud-based services accessible to a user device.

In this example, the APT generation system 100 is in communication (e.g., over a wired or wireless network) with a user device 10 and a generic APT database 150.

The generic APT database 150 may be external to the APT generation system 100 (as shown) or may be part of the APT generation system 100. In some examples, the APT generation system 100 may also be in optional communication with another external storage 160 that may be a memory for storing information such as an optimization model, data schema and operations plan (e.g., an optimization model, data schema and/or operations plan previously uploaded via the user device 10 or previously generated using an APS), and which may be used to store outputs generated by the APT generation system 100 (e.g., may be used to store the customized APT after deployment). In some examples, the storage 160 may be a cloud-based storage. In some examples, the APT generation system 100 may be part of an APS (not shown).

The APT generation system 100 receives input information from the user device 10 (and optionally may retrieve information from storage 160) and generates output information that may be presented to the user via the user device 10. The input information from the user device 10 and optionally the storage 160 may be multimodal information, including one or more questions (e.g., a natural language list of questions, which may be inputted by the user via the user device 10), code representing an optimization model, data object representing a data schema and data object representing an operations plan. In some examples, the optimization model, data schema and/or operations plan may be uploaded to the APT generation system 100 via the user device 10. In some examples, the user may provide information (e.g., identifier of a planning scenario) via the user device 10 that the APT generation system 100 may use to retrieve the corresponding optimization model, data schema and/or operations plan from the storage 160. Additionally, the APT generation system 100 may receive one or more generic APTs (where each generic APT includes a generic APT contract and generic APT code) from the generic APT database 150. The APT generation system 100 performs operations, as disclosed herein, to generate as outputs a customized APT contract and APT code (which may both be outputted to be stored in the storage 160 and/or may be outputted to the user via the user device 10).

The input question(s) may be provided by the user as natural language questions that the user wishes to answer using an APT. The input question(s) may be part of a scenario analysis, which a user might perform to simulate how operations may be affected to certain changes to a scenario; among other possibilities. The input question(s) may be provided in the form of a text-based document (e.g., text file, markdown file, JSON file, etc.), via a graphical user interface (GUI) or voice input (which may be converted to text using a voice-to-text conversion algorithm), among other possibilities. As discussed further below, the APT generation system 100 may generate one or more APT to answer the one or more input questions. For example, there may be a one-to-one mapping between questions and APTs (i.e., one APT is generated for each input question) or a multiple-to-one mapping between questions and APTs (i.e., one APT is generated for two or more input questions), however the APT generation system 100 may ensure that each input question results in generation of no more than one APT, meaning for any given input question there is only one APT that would provide the answer. This may help to avoid unnecessary use of computing resources to generate redundant APTs, and may avoid the need for the user to manually select which APT to use to answer a particular question (thus reducing user confusion and reducing the need for user experience). In some examples, one or more of the input questions may be default questions that are provided by the APT generation system 100 as suggestions, which the user may select as the basis for generating an APT. In some examples, the user may create the list of input question(s) from scratch or may add to an existing list of input question(s). In the scenario where a new question is added to an existing list of input question(s), the APT generation system 100 may only generate a new APT for the newly added question, or the APT generation system 100 may process the entire list of input questions again.

The optimization model may be obtained from storage 160 or may be uploaded via the user device 10. The optimization model may be represented by code. The optimization model formulates the entities, decision activities, objective, and constraint/bounds defining the business operations, and may be editable (e.g., the user may update the optimization model a new constraint is added to business operations).

The data schema may be obtained from storage 160, may be uploaded via the user device 10 (e.g., uploaded as a data file such as a *.csv or *.xlsx file) or may be populated via user inputs to a GUI, for example. The data schema is a data object that defines the entities of the problem (e.g., drivers, routes, regions in the example of a ride-share optimization problem), the relationships between entities, and the metrics (e.g., profits, customer wait time, driver idle time) of the optimization problem. The data schema is used to align the input parameters with the data that is available.

The operations plan may be obtained from storage 160, may be uploaded via the user device 10 (e.g., uploaded as a data file such as a *.csv or *.xlsx file) or may be created via a GUI, for example. The operations plan serves as a reference indicating the current decisions that are being made. An APT may use the operations plan as a basis for describing the possible changes to the plan and may be used to provide context when the APT generates an explanation for the benefits and limitations of alternative scenarios. An APT may be used to edit the operations plan.

FIG. 1B illustrates an example of inputs that may be for a ride-share business. The inputs include a list of questions 102, an operations plan 104, a data schema 106 and an optimization model 108. The list of questions 102 may include questions that pose an optimization problem (e.g., “Which week should we release a discount?”), questions that pose alternative scenarios (e.g., “What is the impact on our profit if we acquire 100 more drivers in the downtown area?”) and questions about the existing operations plan (e.g., “Show me the current hot spots.”). It should be understood that the questions 102 may be phrased as questions or statements.

The APT generation system 100 may retrieve a generic APT from the generic APT database 150. The generic APT includes a generic APT contract and generic APT code. A generic APT serves as a skeleton with placeholders that the APT generation system 100 will complete, to generate a customized APT. For example, a generic APT may be a skeleton for performing a generic function such as exploring the impact on a generic metric when changing a generic parameter. An OR consultant or other expert may have previously developed each generic APT, including the core algorithms of the APT and/or connections to appropriate OR engine endpoints. Each generic APT may be designed to be mapped to a particular set of questions. Many questions can be mapped to just a few generic APTs.

The outputs from the APT generation system 100 include a customized APT contract and customized APT code, which together form the customized APT. The customized APT contract may be outputted to be presented to the user (e.g., via the user device 10). The customized APT code may, after being deployed, be stored in memory, such as on a cloud-based system (which may be the storage 160, for example).

The customized APT contract provides a natural language description of the corresponding customized APT and may serve as the documentation for the customized APT. For example, the APT generation system 100 may output the customized APT contract to the user device 10 to enable a user to understand the function and usage of the generated customized APT. The customized APT contract may include the description, required input parameters and their details such as type, an output schema, and optionally some input and output examples. The description and input parameters may provide information for how to call the customized APT. The output schema details the fields in the output object generated by the customized APT. Input and output examples (and possibly some sensitivity analysis) can be automatically generated by the APT generation system 100 and may be used by the user to validate the output of the customized APT in a common-sense manner. The generated input/output examples and/or sensitivity analysis may optionally be included in the customized APT contract. As will be discussed further below, the customized APT contract is generated by the APT generation system 100 based on the input question(s), data schema and generic APT contract.

The customized APT code is the code that is executed to implement the customized APT. There is one customized APT code file for one customized APT contract. When given the input parameters described in the customized APT contract and the code is executed, the output defined by the output schema of the customized APT contract is generated. Example inputs may be provided to the code to generate example outputs that may be included in the customized APT contract. Tests such as sensitivity analysis may also be performed using the code and the results may be added to the customized APT contract. As will be discussed further below, the customized APT code is generated using the customized APT contract, operations plan, optimization model and generic APT code.

FIG. 1C illustrates an example of a customized APT contract based on the example inputs of FIG. 1B. The customized APT contract includes a natural language description 112 of the customized APT, which describes the input parameters, the function and the output of the customized APT. The customized APT contract also includes a definition of accepted input parameters 114, an output schema 116 that defines the format of the output. In this example, the customized APT contract includes the results of a sensitivity test 118, which may be used by a user to validate the customized APT; in other examples, other forms of example inputs and outputs may be provided by a customized APT contract; in yet other examples, the customized APT contract may not include example inputs/outputs and/or may not include the results of a sensitivity test.

The customized APT contract may be used to update a previously generated customized APT. For example, a user may edit the natural language description 112 and the APT generation system 100 may process the edited description 112 to update the customized APT accordingly, as discussed further below. This may enable a non-expert user to more easily update an APT, without having to manually change the code. The input question(s) and the data schema of the operations plan that is the target of the customized APT are included in the customized APT. This helps to ensure that the input parameters of the customized APT aligns with the format and input data that is available, as well as ensuring that the customized APT answers at least one of the input questions.

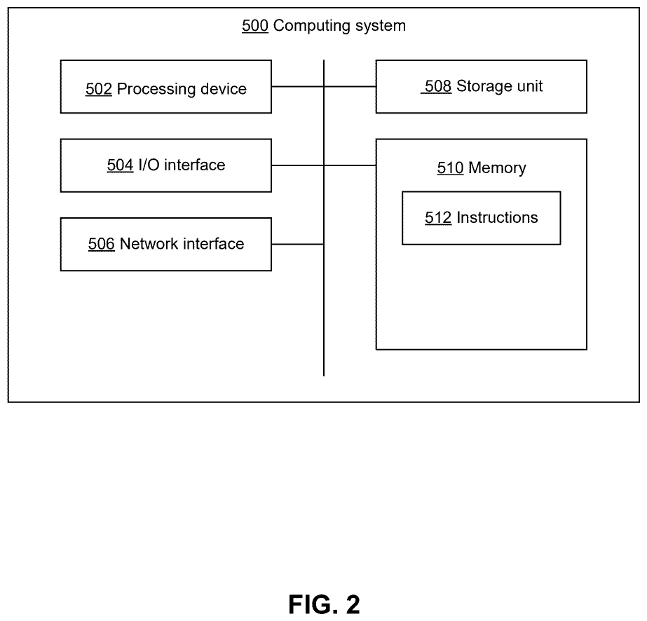

FIG. 2 is a block diagram illustrating a simplified example computing system 500 that may be used for implementing the APT generation system 100, in some embodiments. The computing system 500 may represent a server or a workstation, for example. As discussed previously, the APT generation system 100 may be implemented in other hardware configurations, including implementation using a plurality of computing systems. Although FIG. 2 shows a single instance of each component, there may be multiple instances of each component in the computing system 500.

In this example, the computing system 500 includes at least one hardware processing device 502, which may be a processor, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, combinations thereof, or other such hardware structure.

The computing system 500 may include an input/output (I/O) interface 504, which may enable interfacing with an input device and/or output device (not shown).

The computing system 500 may include a network interface 506 for wired or wireless communication with other computing systems (e.g., the generate APT database 150, the storage 160, the user device 10, etc.). The network interface 506 may include wired links (e.g., Ethernet cable) and/or wireless links (e.g., one or more antennas) for intra-network and/or inter-network communications. The network interface 506 may also enable the computing system 500 to communicate outputs (e.g., generated customized APT contract and code) to another computing system (e.g., to the user device 10 and/or to the storage 160).

The computing system 500 may include a storage unit 508, which may include a mass storage unit such as a solid state drive, a hard disk drive, a magnetic disk drive and/or an optical disk drive.

The computing system 500 may include a memory 510, which may include a volatile or non-volatile memory (e.g., a flash memory, a random access memory (RAM), and/or a read-only memory (ROM)). The non-transitory memory 510 may store instructions for execution by the processing device 502, such as to carry out example embodiments described in the present disclosure. For example, the memory 510 may store instructions 512 for implementing the APT generation system 100 as well as any of the methods disclosed herein. The memory 510 may include other software instructions, such as for implementing an operating system and other applications/functions.

The computing system 500 may additionally or alternatively execute instructions from an external memory (e.g., an external drive in wired or wireless communication with the server) or may be provided executable instructions by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

Reference is again made to FIG. 1A. In the example shown, the APT generation system 100 includes an APT contract generator 200, an APT implementor 300 and an APT instance verifier 400 as subsystems. It should be understood that, in some embodiments, the APT generation system 100 may have greater or fewer subsystems than that shown in FIG. 1A. For example, operations described as being performed by a particular subsystem may be performed by a different subsystem of the APT generation system 100. In yet other examples, the APT generation system 100 may itself provide the functions of APT contract generation, APT implementation and/or APT verification, without having subsystems 200, 300 and/or 400. It should be understood that the APT generation system 100 may be implemented using various hardware and software, and is not intended to be limited to the example shown in FIG. 1A.

The APT contract generator 200 processes the input question(s) one by one, together with the data schema, to generate a set of one or more customized APT contracts using one or more generic APT contracts. The APT contract generator 200 identifies a generic APT contract for an input question, then maps placeholder variable names in the generic APT contract to those defined in the data schema, in order to generate a customized APT contract for that input question. Each customized APT contract will be the basis of a corresponding customized APT generated by the APT generation system 100.

The APT contract generator 200 may generate one customized APT contract for each input question, or may group multiple input questions with one customized APT contract. For example, the APT contract generator 200 may determine that multiple input questions can be mapped to the same customized APT contract, or the APT contract may determine that duplicates of the same customized APT contract has been generated for multiple input questions and may remove the duplicates so that the customized APT contract is unique.

Each customized APT contract generated by the APT contract generator 200 is provided as input to the APT implementor 200. The APT implementor 200 processes the customized APT contract, together with the optimization model, operations plan, and generic APT code to generate customized APT code. The customized APT contract may include information identifying the generic APT contract that was the basis of the customized APT contract, and this information may be used by the APT implementor 200 to obtain the corresponding generic APT code. Then the APT implementor 200 maps placeholder variable names in the generic APT code to those defined in the data schema, in order to generate the customized APT code.

In some examples, the APT implementor 300 may make use of a trained model (e.g., a trained LLM) to generate code snippets. An LLM in the present disclosure may refer to any suitable machine learning model that has been trained to generate text output based on a text prompt input. Examples of LLMs include Llama2, Mistral 7B, GPT-3 or GPT-4, among others.

The APT implementor 300 may automatically generate the customized APT code without requiring any human input (e.g., prompt engineering or manual entry of LLM prompts). The generic APT code may already include generic code for calling an OR engine endpoint, such that the APT implementor 300 can generate customized APT code to interface with these endpoints. As well, by starting from generic APT code rather than relying on an LLM to generate the code from scratch, for example, the risk of generating erroneous code may be reduced. The APT implementor 300 may be used to update the customized APT code, for example if the optimization model or data schema changes, without requiring the user to manually update the code.

Each customized APT code generated by the APT implementor 300 is provided to the APT instance verifier 400 together with the corresponding customized APT contract. As discussed below, the APT instance verifier 400 performs test executions of the customized APT to ensure that the customized APT is executable. The APT instance verifier 400 may also be used for sensitivity analysis, which determines whether changes to a certain input parameter will significantly affect the output decision or metric and in what way. The higher the sensitivity of the output is to a certain parameter, the more that certain parameter impacts the output.

The APT instance verifier 400 uses the data schema to generate variant input calls to the customized APT. The APT instance verifier 400 checks the customized APT code by creating some sample APT calls based on the data schema (e.g., if a parameter is discrete, the APT instance verifier 400 may loop through all possible values and ensure that the customized APT code is executable for each possible value; if a parameter is continuous, the APT instance verifier 400 may select sample values in the range of possible numerical values and ensure that the customized APT code is executable for each sampled value). These sample APT calls may enable the APT instance verifier 400 to check that the customized APT code is compilable and executable. Additionally, the APT instance verifier 400 can collect the input and output variants from the sample APT calls and add these to the customized APT contract and/or presented to the user via the user device 10. By automating the verification process using the APT instance verifier 400, the need for a human to manually perform and check test scenarios can be avoided.

The APT instance verifier 400 may also perform sensitivity tests by fixing the value of all parameters in a scenario except for one parameter. Then, by tuning the one non-fixed parameter (e.g., slightly nudging the value of the non-fixed parameter higher or lower in the scenario) and collecting the output, the APT instance verifier 400 is able to perform a sensitivity test that demonstrates the sensitivity of the output to that particular non-fixed parameter. The results of the sensitivity test may be included in the customized APT contract and/or presented to the user via the user device 10. This information may enable a user to verify the APT with more confidence when given a sensitivity plot that describes a trend of how sensitive the solution is to the change in a parameter.

If the APT instance verifier 400 determines that the customized APT code fails to compile or encounters an error in a sample call, the APT instance verifier 400 may request the APT implementor 300 to re-implement the code. The APT instance verifier 400 may additionally provide information to the APT implementor 300 about the failure (e.g., an error code encountered and the sample input that resulted in the error). The APT implementor 300 may use the information to generate another iteration of the code implementation. This loop between the APT instance verifier 400 and the APT implementor 300 may be repeated until the customized APT code is successfully verified by the APT instance verifier 400 or until a maximum number of attempts (e.g., 10 iterations of the code implementation) is performed.

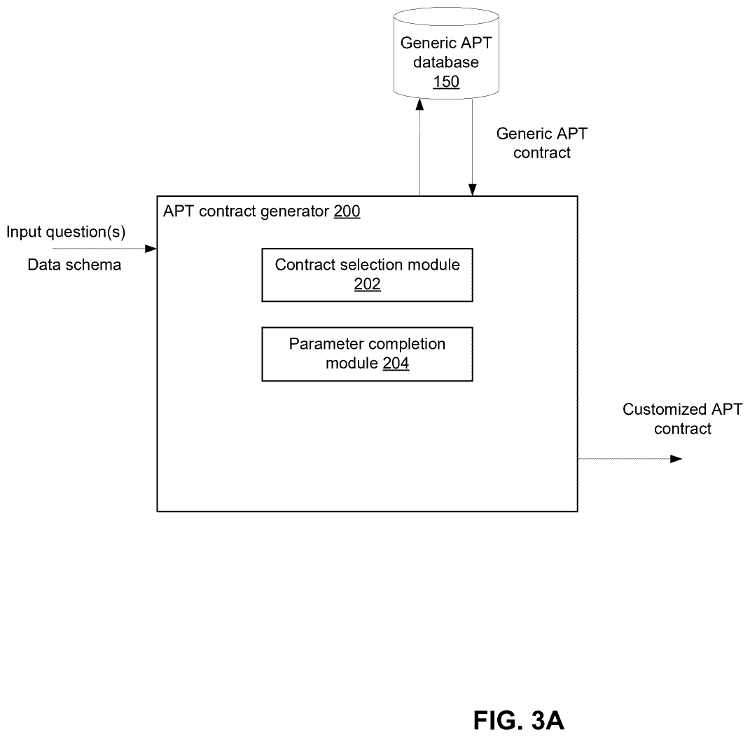

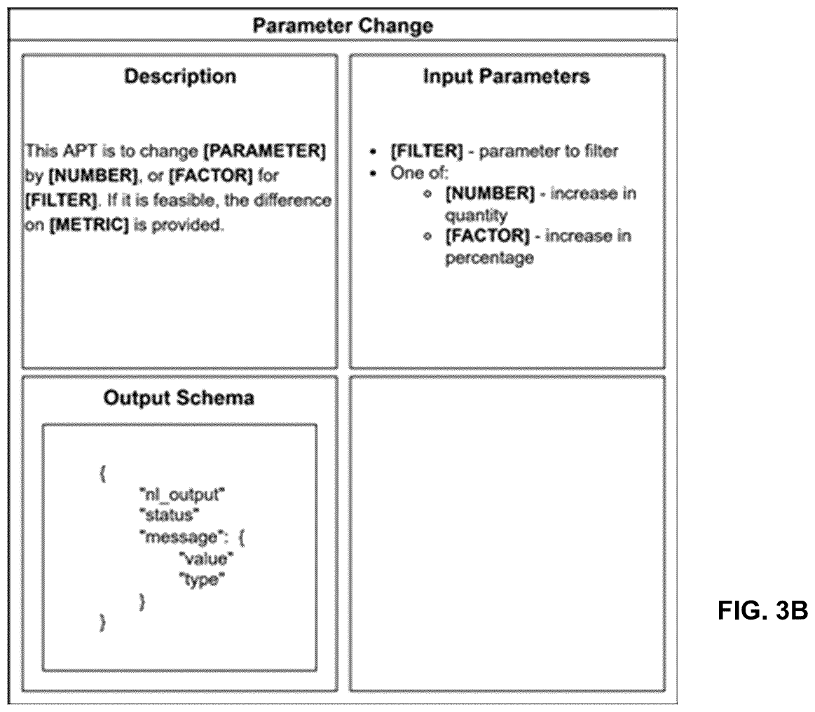

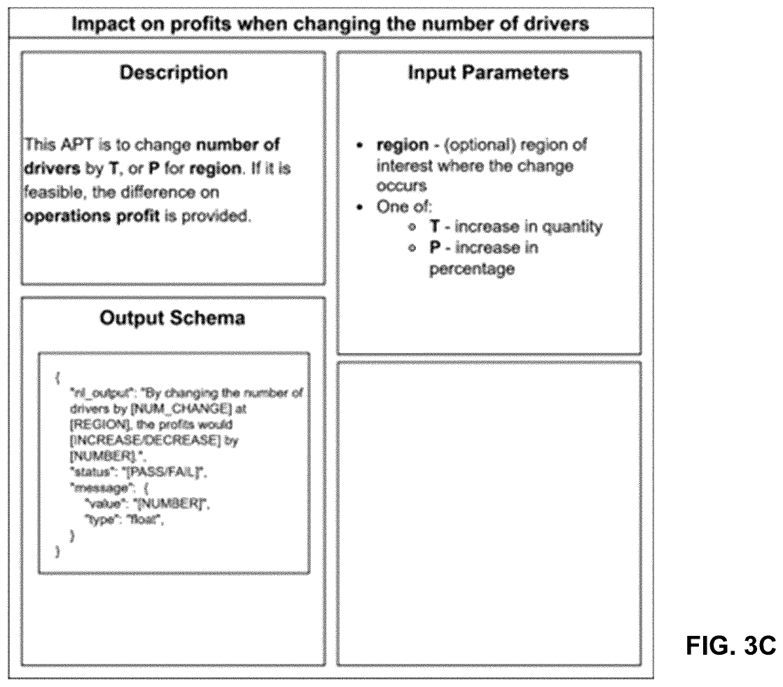

FIG. 3A is a block diagram showing details of an example APT contract generator 200. The APT contract generator 200 receives the input question(s) as well as the data schema. For a given input question, the APT contract generator 200 retrieves a relevant generic APT contract from the generic APT contract database 150 and customizes the generic APT contract to the given question and the entities and/or metrics defined in the data schema, and outputs a customized APT contract.

If multiple input questions are provided as input, the APT contract generator 200 may iterate through the questions one at a time, to generate a customized APT contract for each question. The customized APT contract contains the natural language description of the customized APT, input parameters and output schema. Optionally, input/output examples and/or results of sensitivity tests which will be generated by the APT instance verifier 400 may be added later to the customized APT contract.

As previously mentioned, in some examples the APT contract generator 200 may determine that two or more questions can be addressed by one APT, in which case one customized APT contract may be generated for those two or more questions. For example, the APT contract generator 200 may retrieve relevant generic APTs for each question in the list of input questions, and questions that map to the same generic APT may be grouped as one cluster. It should be understood that one generic APT may be used to create two distinct customized APTs that perform different functions. For example, a generic APT may calculate the impact on a metric when changing a parameter, such as documented by the generic APT contract shown in FIG. 3B. Two example questions that may map to this same generic APT but require different input parameters (and thus require generation of two different customized APTs), may be: “How is my profit impacted if I hire less drivers?” and “How much less will my drivers need to idle for if we increase the number of cars by 10%?”. Note that both questions would map to the same generic APT contract shown in FIG. 3B because they are both examining the impact of changing a parameter on some metric, despite the two questions requiring different input parameters and different outputs.

Thus, instead of grouping questions based on the generic APT contracts being in common, grouping of questions may be based on the customized APT contracts. That is, the APT contract generator 200 may process each input question and generate a customized APT contract for each input question, without considering whether any two questions may be grouped together. Then, after all customized APT contracts have been generated (one per question), the customized APT contracts that were built from a common generic APT contract are compared. If two customized APT contracts, which were built from a common generic APT contract, have identical input parameters (ignoring optional inputs) as well as identical output schemas, the two customized APT contracts are considered to be identical and only one of the two customized APT contract is kept.

Reference is again made to FIG. 3A. In this example, the APT contract generator 200 includes a contract selection module 202 and a parameter completion module 204. It should be understood that the modules 202, 204 are only exemplary and are not intended to limit the APT contract generator 200 or the APT generation system 100 to the example shown. For example, there may be greater or fewer modules in the APT contract generator 200, and operations being described as being performed by a particular module may be performed by a different module. The operation of the APT contract generator 200 will be described below with reference to one given input question from the list of one or more input questions.

The contract selection module 202 may use the given question and the data schema to form a query (e.g., by concatenating the given question and elements of the data schema) that is encoded into a query embedding. The contract selection module 202 may perform the encoding using any suitable embedding generator such as a BERT model (e.g., as described by Devlin et al. “BERT: Pre-training of Deep Bidirectional Transformers for Language Understanding” arXiv:1810.04805, 2018). Each generic APT stored in the generic APT database 150 may be represented by a corresponding generic APT embedding generated using the description and input parameters of the corresponding generate APT contract, using an embedding generator. Then, based on similarly between the query embedding and each generic APT embedding (e.g., using cosine similarity), the top-k (e.g., where k=3) matching generic APT contracts may be selected as candidate generic APT contracts. In some examples, the generic APT embedding corresponding to a candidate generic APT contract must also have similarity to the query embedding above a threshold (e.g., over 70% similarity). In some examples, the candidate generic APT contracts may be presented to the user via the user device 10, to enable the user to select which generic APT contract to use as the basis for generating a customized APT. In some examples, all candidate generic APT contracts may be passed to the next modules of the APT contract generator 200 and reranked after parameter filling. In some examples, k is equal to one and only one generic APT contract is returned by the contract selection module 202. The operations of the following modules will be described with reference to one selected generic APT contract.

The generic APT contract has placeholders (such as [PARAMETER], [NUMBER], [FILTER], [FACTOR] or [METRIC], as shown in the example of FIG. 3B) that need to be filled so that the resulting customized APT aligns with the business entities and metrics defined in the data schema. The task of entity recognition and parameter filling may be performed by the parameter completion module 204.

In some examples, the parameter completion module 204 may implement a weakly supervised named entity recognition (NER) task that uses a NER model that can be deployed without any labelled data from the target domain (e.g., as described by Lison et al., “Named Entity Recognition without Labelled Data: A Weak Supervision Approach”, arXiv:2004.14723, 2020). When using this approach, the target labels (which are the entities to be detected) are the placeholder names found in the generic APT contract and these labels are to be detected from the entities and metrics defined in the data schema. When a label (e.g., a distinct placeholder, such as the bold text within square brackets shown in FIG. 3B) has a corresponding value detected in the data schema, the parameter completion module 204 may replace the placeholder by the values in the data schema. The customized APT contract is obtained by filling all the placeholder labels with appropriate information from the data schema.

In some examples, instead of using a NER model, the parameter completion module 204 may use a fine-tuned LLM such as Llama2-70b (e.g., as described by Touvron et al. “Llama 2: Open Foundation and Fine-Tuned Chat Models” arXiv:2307.09288, 2023) to identify and fill the placeholders. The parameter completion module 204 may generate a prompt indicating the parameter completion task to be performed by the LLM and provide the LLM with the given question, data schema and the generic APT contract. The customized APT contract, with placeholders filled in with appropriate parameters, may then be obtained as the output generated by the LLM. An example prompt that the parameter completion module 204 may generate to the LLM is as follows:
″″″
You are an expert in Operations Research, specifically in the field of {schema.domain}. I am making an advanced planning tool and need your help to build the contract for this tool.
I will provide you a data schema that details the entities and metrics of our business following “SCHEMA:”. I will also provide you an example of a question that this tool needs to answer following “QUESTION:”. I will then give you the contract following “CONTRACT:” with some placeholders that are surrounded with square brackets [ ]. Please return the completed filled specific contract for the advanced planning tool. DO NOT CHANGE ANYTHING OTHER THAN FILLING THE PLACEHOLDERS.
Here is an example:
SCHEMA:
{ICL.schema}
QUESTION:
{ICL.question}
CONTRACT:
{ICL.contract}
OUTPUT:
{ICL.output}
Please create the specific advanced planning tool for this problem:
SCHEMA:
{ICL.schema}
QUESTION:
{ICL.question}
CONTRACT:
{ICL.contract}
OUTPUT:
″″″

The output from the LLM may also include a confidence score. If there are multiple generic candidate APT contracts, a customized APT contract may be generated for each candidate, then the customized APT contract with the highest average confidence score from the parameter completion module 204 may be outputted as the customized APT contract for the given question. The APT contract generator 200 may communicate with an external system hosting a LLM, or may include a LLM, in examples where a LLM is used.

FIG. 3C illustrates an example customized APT contract that may be generated based on the generic APT contract of FIG. 3B, using a NER model or using a LLM (or a combination thereof) as discussed above. In this example, the placeholders [PARAMETER], [NUMBER], [FILTER], [FACTOR] and [METRIC] in the generic APT contract of FIG. 3B have been replaced by “number of drivers”, “T”, “region”, “P” and “operations profit” in the customized APT contract of FIG. 3C, based on the data schema.

The APT contract generator 200 may perform operations, as described above, to generate one or more customized APT contracts, corresponding to one or more customized APTs that together can address all of the input questions. If each question is addressed by a unique customized APT, then the number of customized APT contracts generated by the APT contract generator 200 is equal to the number of input questions. The customized APT contract that has been generated up to this point may be considered a “partial” customized APT contract because sample input/output variants have not yet been included. In some examples, the customized APT contract may be used without requiring sample input/output variants to be added.

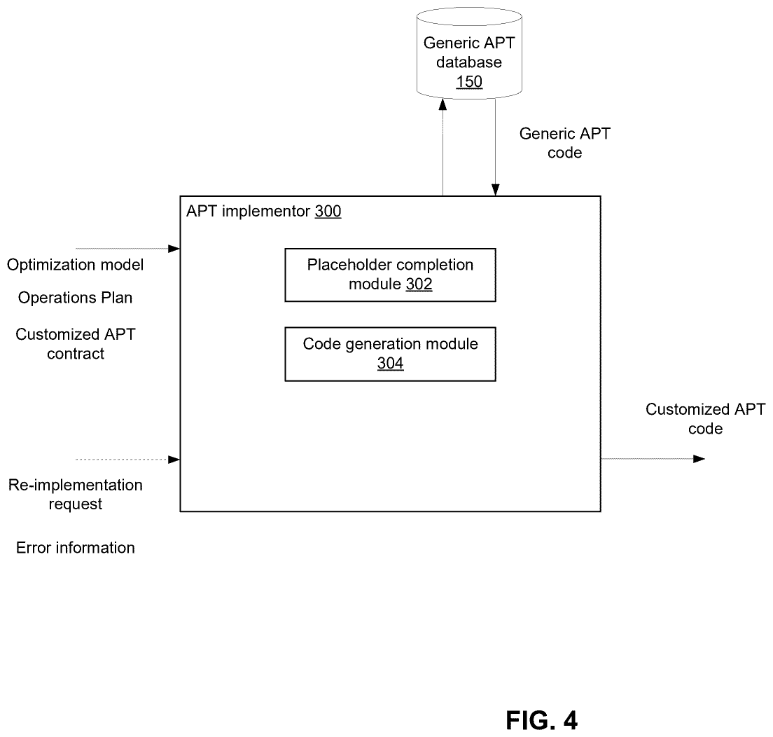

FIG. 4 is a block diagram showing details of an example APT implementor 300. The APT implementor 300 receives the optimization model and operations plan as inputs, along with the customized APT contract generated by the APT contract generator 200. The APT implementor 300 obtains the generic APT code corresponding to the generic APT contract that the customized APT contract is based on, and generates customized APT code, which is the APT implementation. The customized APT code may be deployed to a cloud-based storage, for example.

In some examples, the customized APT contract inputted to the APT implementor 300 may be a customized APT contract for a previously implemented customized APT that has been edited (e.g., by a user). For example, a user (e.g., via a UI as discussed below) may be able to update the natural language description in the customized APT contract or revise the input parameters to better fit the business scenario. The edited customized APT contract may be processed by the APT implemented 300, in the manner discussed below, to generate new customized APT code according to the edits.

In this example, the APT implementor 300 includes a placeholder completion module 302 and a code generation module 304. It should be understood that the modules 302, 304 are only exemplary and are not intended to limit the APT implementor 300 or the APT generation system 100 to the example shown. For example, there may be greater or fewer modules in the APT implementor 300, and operations being described as being performed by a particular module may be performed by a different module. The APT implementor 300 may perform operations as described below to generate customized APT code for each customized APT contract generated by the APT contract generator 200. The operation of the APT implementor 300 will be described below with reference to generation of customized APT code from one customized APT contract.

The APT implementor 300 may identify the generic APT contract that the customized APT contract is based on, and retrieve the corresponding generic APT code from the generic APT database 150. Alternatively, the APT contract generator 200 may retrieve the generic APT code together with the generic APT contract and provide the generic APT code to the APT implementor 300.

The placeholder completion module 302 may replace placeholders in the generic APT code based on how the parameter completion module 204 mapped placeholders in the generic APT contract to specific values in the data schema. The generic APT code has the same placeholder tags as the generic APT contract, so the placeholder-to-data schema mapping used to generate the customized APT contract may be similarly used by the placeholder completion module 302 to complete the placeholders in the generic APT code. This may avoid the need for the placeholder completion module 302 to perform NER, which may be a more efficient use of computing resources. For example, the APT contract generator 200 may provide the placeholder-to-data schema mapping to the APT implementor 300, and the placeholder completion module 302 may replace each placeholder in the generic APT code based on the provided mapping. In some examples, the placeholder completion module 302 may compare the generic APT contract with the customized APT contract to determine the placeholder-to-data schema mapping and replace each placeholder in the generic APT code based on the determined mapping. For example, based on the mapping of [FILTER] to “region” as shown in FIGS. 3B and 3C, the APT implementor 300 may replace each instance of [FILTER] in the generic APT code with “region”, so that the resulting customized APT code will align with the parameters defined in the data schema. If the generic APT code does not have any further placeholders, such as a placeholder code section, then the replacement of placeholder tags with specific names from the data schema may be sufficient to generate the customized APT code from the generic APT code. If there is still a placeholder code section remaining after the placeholder-to-data schema mapping, then the result of the mapping may be semi-generic APT code that requires further processing by the APT implementor 300.

If the semi-generic APT code includes a placeholder code section, then in addition to replacing placeholders with named parameters from the data schema, the semi-generic APT code may require addition of code snippets to replace the placeholder section, such as to define a constraint or to define a metric. For example, the semi-generic APT code may include a placeholder section for a defining a metric, indicated by the tags <DEFINE_METRIC> and </DEFINE METRIC>. The placeholder section for a metric definition may be followed by a call to a relevant OR engine endpoint to solve for the metric according to the definition.

The code generation module 304 may use a LLM to generate a code snippet to replace a placeholder section. The code generation module 304 may communicate with an external system hosting a LLM, or the APT implementor 300 may include a LLM, for example. The LLM may be fine-tuned on optimization modeling languages, in order to obtain a LLM well-suited to generate specific code relevant to the optimization model and/or data. Some examples of suitable LLMs that may be fine-tuned on optimization modeling languages include Pyomo (e.g., described by Hart et al. Pyomo: modeling and solving mathematical programs in Python (Vol. 3). Springer, 2011), PuLP (e.g., described by Dunning et al. “PuLP: A Linear Programming Toolkit for Python”, 2011) or AMPL (e.g., described by Fourer et al. AMPL: A Modeling Language (2^{nd} ed.) Cengage Learning. 2003), or any other LLM that can be fine-tuned. The code generation module 304 may generate a prompt indicating the code generation task to be performed by the LLM and provide the LLM with the optimization model, optimization plan, customized APT contract and the semi-generic APT code. The customized APT code, with placeholder sections completed with generated code, may then be obtained as the output generated by the LLM. An example prompt that the code generation module 304 may generate to the LLM is as follows:
″″″
You are an expert in Operations Research, specifically in the field of {schema.domain}. I am making an advanced planning tool and need your help to write the contract for this tool.
I will provide you the optimization model code following “MODEL:”. This code is written in {schema.model_language}. I will also provide you the optimization plan following “PLAN:” and the contract describing the API following “CONTRACT:”. I will then give you a skeleton code that will connect you to any needed OR Engine Endpoints. DO NOT CALL ANY ENDPOINTS. You simply need to fill in the sections that are highlighted by the XML tags. Your main task is to add/revise variables and constraints as well as define metrics. Follow the format such that it compiles when added to the optimization model code that follows “MODEL:”. DO NOT CHANGE ANYTHING OTHER THAN ADDING IN THE SECTIONS IDENTIFIED BY THE XML TAGS.
Here is an example:
MODEL:
{ICL.schema}
QUESTION:
{ICL.question}
CONTRACT:
{ICL.contract}
OUTPUT:
{ICL.output}
Please create the specific advanced planning tool for this problem:
SCHEMA:
{ICL.schema}
QUESTION:
{ICL.question}
CONTRACT:
{ICL.contract}
OUTPUT:
″″″

The generated customized APT code may then be deployed, for example to a cloud-based system.

In some examples, the APT implementor 300 may receive a request to re-implement the customized APT code (e.g., from the APT instance verifier 400). The re-implementation request may include error information indicating an error that was encountered in a test execution of the customized APT code.

In general, an error encountered in a text execution of the customized APT code may be assumed to be an error in the code generated by the code generation module 304 (since there is lower likelihood that the error is due to mapping performed by the placeholder completion module 302). When the customized APT code is executed (e.g., in a test execution by the APT instance verified 400, discussed further below), an error message may be generated. For example, an error may be some syntax issue that makes the generated code not compilable (e.g., a missing closing parenthesis may result in an error message such as “SyntaxError: ‘(’ was never closed”), or the error may be that the generated code includes some variable that does not exist (e.g., an erroneous use of a variable “n_drivers” may result in an error message such as “NameError: name ‘n_drivers’ is not defined”). Any errors encountered by the APT instance verifier 400 may be provided to the APT implementor 300.

Consider an example in which the APT instance verifier 400 performs a test execution of the customized APT code but encounters an error “NameError: name ‘n_drivers’ is not defined”. The APT instance verifier 400 may request the APT implementer 300 to re-implement the code, and may provide the error message to the APT implementer 300 together with the customized APT contract, generic code, and the erroneous customized APT code.

The APT implementor 300 may use the code generation module 304 to regenerate the code using a prompt to the LLM as discussed previously. The following is an example prompt that may be provided to the LLM to regenerate code:
″″″
You are an Operations Research expert that is experienced with writing Pyomo code. You need to give me an advanced planning tool for my business. I will provide you the optimization model code following “MODEL:”. This code is written in {schema.model_language}. I will also provide you the optimization plan following “PLAN:” and the contract describing the API following “CONTRACT:”. I will then give you a skeleton code that will connect you to any needed OR Engine Endpoints. DO NOT CALL ANY ENDPOINTS. You simply need to fill in the sections that are highlighted by the XML tags. Your main task is to add/revise variables and constraints as well as define metrics. Follow the format such that it compiles when added to the optimization model code that follows “MODEL:”. DO NOT CHANGE ANYTHING OTHER THAN ADDING IN THE SECTIONS IDENTIFIED BY THE XML TAGS.
Here is an example:
MODEL:
{ICL.schema}
QUESTION:
{ICL.question}
CONTRACT:
{ICL.contract}
OUTPUT:
{ICL.output}
Please create the specific advanced planning tool for this problem:
SCHEMA:
{ICL.schema}
QUESTION:
{ICL.question}
CONTRACT:
{ICL.contract}
You previously gave me this code:
{generated_code}
There was this error:
{error_message}
Please fix the issue and give me the APT code.
OUTPUT:
″″″

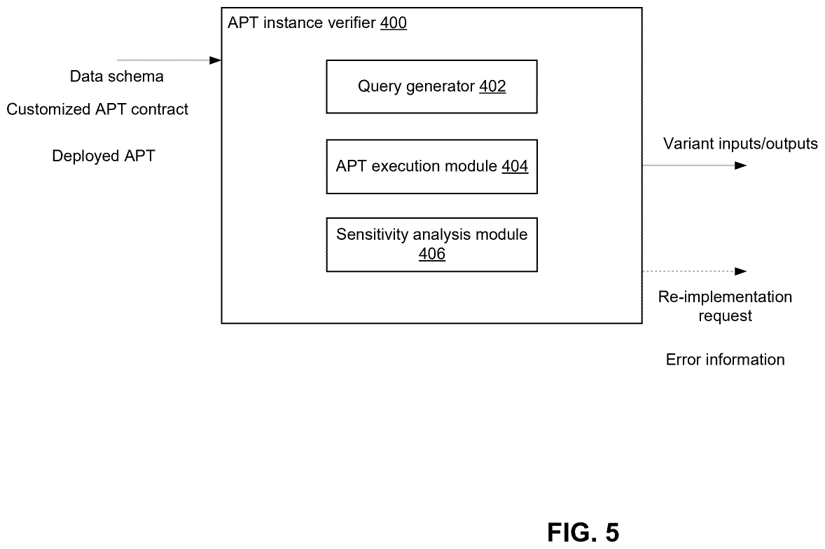

FIG. 5 is a block diagram showing details of an example APT instance verifier 400. The data schema and customized APT, which has been deployed by the APT implementor 300, are received as input to the APT instance verifier 400. The APT instance verifier generates some sample inputs based on the parameter values defined in the data schema and performs test execution of the customized APT. If the customized APT fails to execute, the APT instance verifier 400 sends a re-implementation request (optionally together with error information, such as an error code) to the APT implementer 300 to regenerate the code. In some examples, if the customized APT still fails to execute after re-implementation, the APT instance verifier 400 may again send a re-implementation request to the APT implementor 300, and this re-implementation of the customized APT may be repeated until the customized APT performs all test executions with no error or until a maximum number of re-implementation attempts is reached. For example, the APT implementor 300 may keep a count of re-implementation requests and when the maximum number is reached the APT implementor 300 may, instead of attempting another re-implementation, generate a notification to the user (e.g., notifying the user that the input question is not answerable using the existing optimization model and data schema, or notifying the user that the customize APT contract may contain an error, etc.). If the test executions of the customized APT are successful (i.e., no errors are encountered), the sample inputs and outputs may optionally be added to the customized APT contract as variant inputs/outputs.

In this example, the APT instance verifier 400 includes a query generator 402, an APT execution module 404 and a sensitivity analysis module 406. It should be understood that the modules 402, 404, 406 are only exemplary and are not intended to limit the APT instance verifier 400 or the APT generation system 100 to the example shown. For example, there may be greater or fewer modules in the APT instance verifier 400, and operations being described as being performed by a particular module may be performed by a different module. The APT instance verifier 400 may perform operations as described below to verify each customized APT generated by the APT implementor 300.

The query generator 402 processes the customized APT contract to identify the input parameters to the customized APT, and identifies the entities in the data schema that map to the input parameters. The query generator 402 may generate queries by cycling through possible values for each input parameter, according to the data schema. If the input parameter is a discrete parameter, the generated queries may test all possible discrete values.

For example, consider the customized APT contract shown in FIG. 3C. The input parameters are “region”, “T” and “P”. The data schema may define possible values for “region” as “downtown”, “east side”, “north side”, “west side”. The query generator 402 may then generate queries for each of these possible values for “region”. If the input parameter is continuous parameter (e.g., a numerical parameter), the generated queries may test sample values within the range defined by the data schema and/or may test sample perturbations (e.g., sampled from between +50% to −50%, or between −10 to +10) to the current parameter value in the operations plan. An example query generation by the query generator 402 may be for sample inputs “region”=“downtown”, “P”=5% (corresponding to a question such as “What if the number of drivers in the downtown area is increased by 5%?”).

The APT execution module 404 may call the customized APT (e.g., via an endpoint deployed by the APT implementor 300) using the generated queries. If the deployed customized APT fails any of the test executions, the APT execution module 404 may collect any error information (e.g., error code) and may provide the error information to the APT implementor 300 together with a request for reimplementation. After reimplementation, the APT instance verifier 400 will repeat generation of the queries and perform the test executions again. If the deployed customized APT successfully produces outputs for all of the generated queries, the inputs of the queries and the resulting outputs may be added as variant inputs/outputs to the customized APT contract. For the example query described above, the generated output may be that the metric “Profit” increase by 500; then the sample inputs “region”=“downtown”, “P”=5% and sample output “Profit”=+500 may be included in the customized APT contract.

In addition to generating and providing a variety of queries to test execution of the customized APT, the APT instance verifier 400 may use the query generator 402 to generate queries for performing sensitivity analysis tests in which one input parameter is changed over a range of possible values while the remaining input parameters remain unchanged. The query generator 402 may generate queries for a given operations plan, in which one input parameter is changed from its planned value and provide the queries to the APT execution module 404. The outputs from execution of the customized APT over these queries may be collected. The sensitivity analysis module 406 may then perform statistical analysis on the outputs, such as calculating the standard deviation of the output values (e.g., profit, driver idle time, customer wait time) over the range of the changing input parameter values. This process may be performed for each adjustable input parameter, and each input parameter may be ranked in the order of sensitivity (where an input parameter whose change has a larger effect on the output means the plan is more sensitive to that input parameter) and/or categorized into different levels of sensitivity. In this way, the APT instance verifier 400 may automatically perform sensitivity analysis testing, without requiring user input to specify the queries and statistical analysis. In some examples, additionally or alternatively, the APT instance verifier 400 may accept user input for performing sensitivity analysis tests. For example, user input may be accepted (e.g., via a UI) specifying which input parameter(s) to test and over what range(s) and the APT instance verifier 400 may generate queries and perform executions of the customized APT accordingly. In some examples, the APT instance verifier 400 may automatically propose some sensitivity tests (e.g., may automatically identify the input parameter(s) and range(s) to be queries) that the user can confirm or edit (e.g., via a UI) before the test executions are performed.

For example, consider the customized APT contract shown in FIG. 3C. The sensitivity analysis may test sensitivity to the input parameter “P” representing the percentage change in the number of drivers, while fixing the parameter “region”. A range of input values may be automatically generated by the query generator 402 using values sampled from the range of −50% to 50% (the range may be predetermined programmatically or provided as user input) and a set of resulting outputs (e.g., the metric “Profit”) are collected by the APT execution module 404 calling the deployed customized APT. The sensitivity analysis module 406 may then calculate a first standard deviation for the set of outputs. Using the same procedure, outputs may be collected where the parameter “region” is changed while the input parameter “P” is unchanged, and a second standard deviation is calculated for this second set of collected outputs. The standard deviations may then be compared and ranked, with a larger standard deviation indicating that the output is more sensitive to that particular input parameter. For example, if the first standard deviation (corresponding to “P” being the varied parameter) is smaller than the second standard deviation (corresponding to “region” being the varied parameter), this means that the output “profit” is more sensitive to changes in the input parameter “region” and is less sensitive to changes in the input parameter “P” (which represents the percentage change in the number of drivers).

A sensitivity curve, which is a plot of output values versus a changing input parameter, may be automatically generated by the sensitivity analysis module 406 and included in the customized APT contract, for example. By providing this information in the customized APT contract, the user may be provided with output that can be more easily understood, to enable the user to understand and more efficiently validate the correctness of the customized APT. If the user wishes to review the customized APT code, the user may also do so by accessing the customized APT code via the APS or via the APT generation system 100.

The resulting customized APT contract, which includes a description of the customized APT (e.g., a natural language description of the customized function provided by the customized APT), customized input parameters, customized output schema and one or more variant input/outputs, may then be outputted to the user device 10. The customized APT contract and deployed customized APT may be stored (e.g., in the storage 160, which may be a cloud-based storage, or some other memory). The customized APT contract may serve as documentation for the generated customized APT. The customized APT may be called (e.g., via an APT endpoint) by the APS system to perform the customized function.

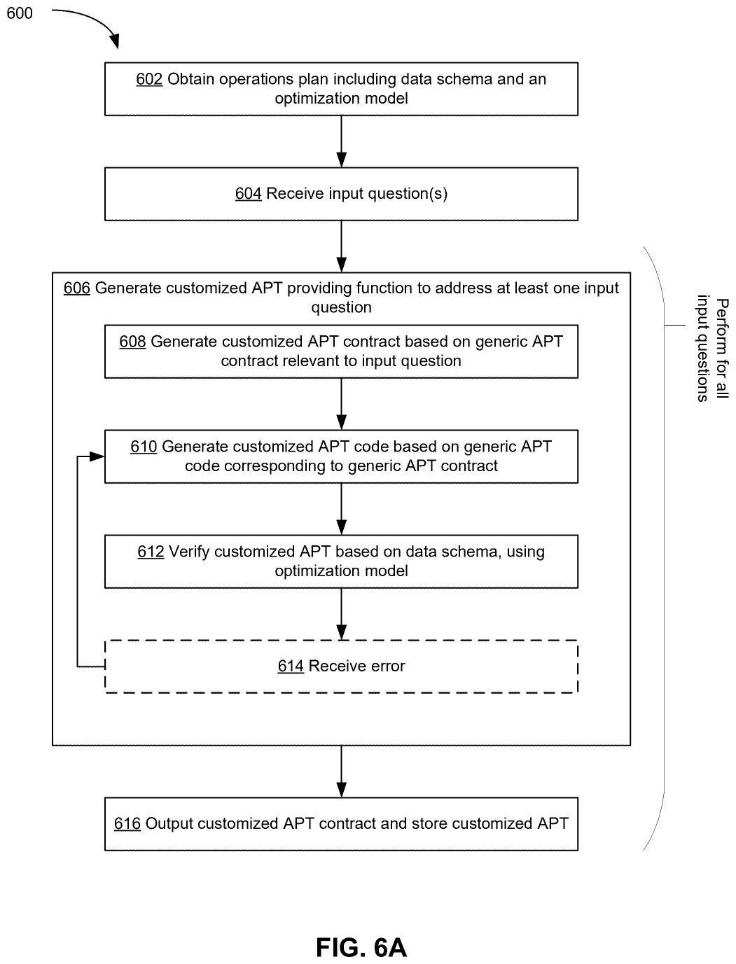

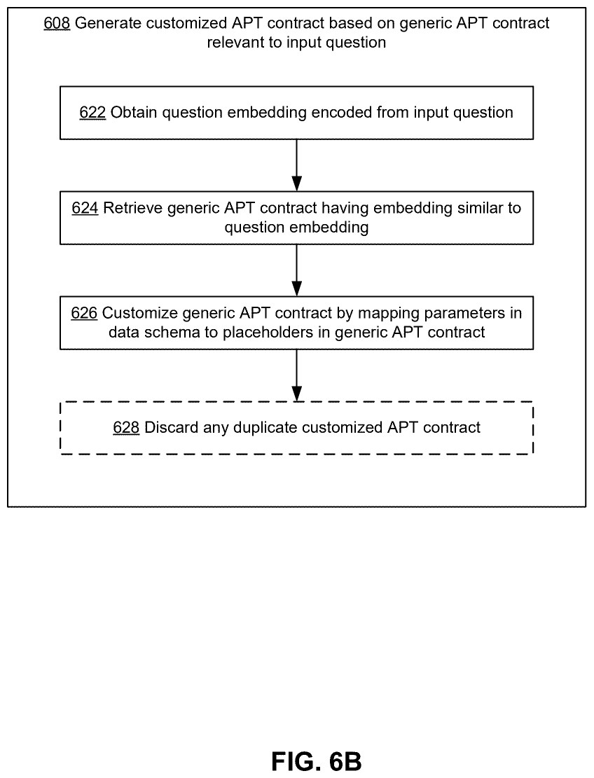

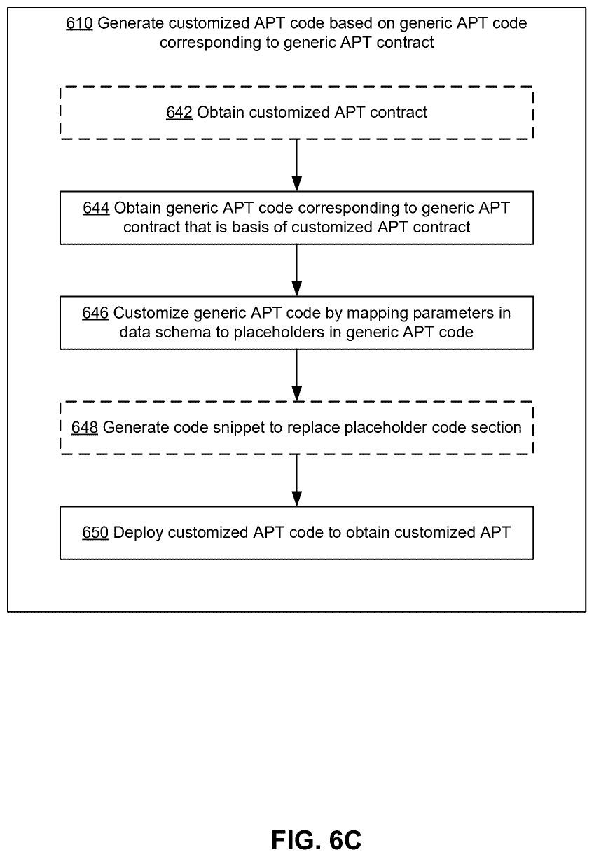

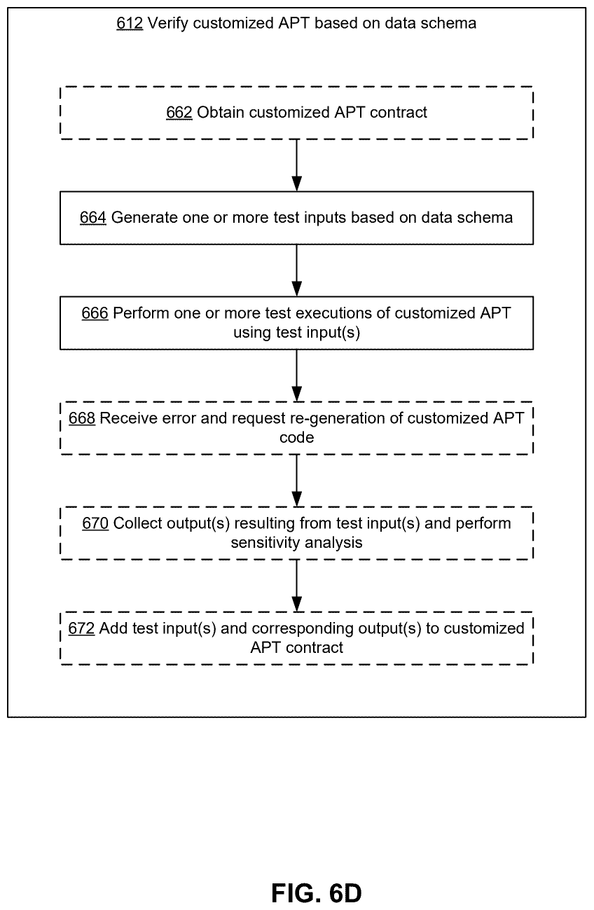

FIG. 6A is a flowchart of an example APT generation method 600, which may be performed using a computing system (e.g., as shown in FIG. 2) implementing an example of the disclosed APT generation system 100. The APT generation method 600 may, in some examples, be implemented using other computing systems and may not necessarily be limited to the APT generation system 100. The APT generation method 600 may be performed by a computing system implementing an APT generation system (which may or may not be based on or include the APT generation system 100), which may or may not be part of an overall APS.

It should be noted that user interaction with the APT generation system 100 may be supported at each or any step of the APT generation method 600. As will be discussed further below, in some examples user interactions (e.g., receiving user inputs and/or providing user outputs) may be via a graphical user interface (GUI) and/or chatbot provided by a computing system (e.g., the computing system that also implements the APT generation system 100).

Examples of the present disclosure may enable a user to generate one or more APTs customized to address one or more input questions, without requiring input from a support consultant or other OR expert. This may help to improve the accessibility of existing APSs as well as expand the functionality of APSs by providing customized APTs with greater ease, lower costs and/or higher efficiency.

At 602, an operations plan with associated data schema and an optimization model are obtained. In some examples, this may be received as input via a user device (e.g., uploaded by a user). In other examples, this may be retrieved from memory (e.g., a storage where operations plans are maintained) based on user input (e.g., user may select which operations plan, data schema and optimization model to retrieve).

At 604, one or more input questions are received. The input question(s) may be received as input via a user device (e.g., uploaded or otherwise inputted by a user). In some examples, one or more of the input question(s) may be a predefined default question. The user may be provided with an option to revise or edit a default question, in some examples.

At 606, a customized APT is generated to provide a customized function to address at least one of the input question(s). A customized APT may be generated to address one input question or to address multiple input questions. It should be understood that the method 600 may be used to generate multiple customized APTs to address multiple input questions. However, for ease of understanding, the generation of one customized APT for at least one given input question will be discussed. Performing step 606 may include performing steps 608, 610, 612 and optionally 614.

At 608, a customized APT contract is generated (e.g., using the APT contract generator 200) based on a generic APT contract that is relevant to the given input question. The generic APT contract defines input parameter(s) and an output schema for a generic function that is determined to be relevant to the given input question. The customized APT contract defines customized input parameter(s) and a customized output schema for the customized APT. Further details of step 608 will be discussed with respect to FIG. 6B.

At 610, customized APT code is generated (e.g., using the APT implementor 300) based on generic APT code corresponding to the generic APT contract used at step 608. The generic APT code provides an implementation of the generic function defined in the generic APT contract. The customized APT code provides an implementation of the customized function of the customized APT, in accordance with the customized APT contract. The customized APT is a deployment of the customized APT code. Further details of step 610 will be discussed with respect to FIG. 6C.

At 612, the customized APT is verified (e.g., by the APT instance verifier 400) based on the data schema, and using the optimization model. Test executions of the customized APT are automatically performed using test input(s) automatically generated based on the data definitions in the data schema. Further details of step 612 will be discussed with respect to FIG. 6D.

Optionally, if an error is encountered during verification at step 612, then at step 614 an error may be received (e.g., an error code or other information about the encountered error). The method 600 may return to step 610 to re-generate the customized APT code (e.g., using the APT implementor 300 and verification is repeated at step 612. Steps 610-614 may be repeated until no errors are encountered at verification and/or until a maximum number of attempts are performed. If an error is still encountered after a maximum number of attempts, then an error may be outputted to the user and generation of the customized APT may be aborted.

At 616, the generated customized APT contract is outputted (e.g., presented to the user via the user device) and the customized APT may be stored (e.g., in cloud-based storage). The user may make use of the customized APT via a UI or chatbot (e.g., as discussed further below), which may be part of an APS, and the customized APT may be executed by calling a corresponding APT endpoint, for example.

In some examples, if the customized APT contract is editable by the user, a revised customized APT contract may be used as the basis for re-generating the customized APT code (e.g., returning to step 610).

It should be understood that steps 606-616 may be repeated to generate as many customized APTs as necessary to address all the input question(s) received at step 604.

Reference is now made to FIG. 6B, showing example steps for performing step 608. For ease of understanding, FIG. 6B will be discussed with respect to generating one customized APT contract relevant to a given input question. However, an example for generating a customized APT contract relevant to multiple input questions will also be discussed.

At 622, a question embedding encoded from the given input question is obtained. For example, an embedding generator such as a BERT model may be used to encode the input question from natural language text into a question embedding representation.

At 624, a generic APT contract corresponding to a contract embedding similar to the question embedding is retrieved. For example, the question embedding may be used to query a database of contract embeddings that are encoded from corresponding generic APT contracts. The generic APT contract corresponding to the contract embedding that is most similar (e.g., closest cosine similarity, or other similarity measure) may be retrieved from the database. The generic APT contract defines generic input parameter(s) and a generic output schema for a generic function that is relevant (based on similarity of embeddings) to the given input question. The generic APT contract may be generic in the sense that placeholders are used in place of specific variable names, and may not include definitions for constraints and/or metrics.

At 626, the generic APT contract is customized by mapping parameters defined in the data schema to placeholders in the generic APT contract. As described previously, this mapping may be performed using a NER approach or using a LLM approach, for example. After the mapping is complete, the customized APT contract defines customized input parameter(s) and customized output schema for the customized APT. The mapping between placeholders and parameters may be saved and/or passed to subsequent steps (e.g., to be used as the mapping for generating the customized APT code).

Steps 622-626 may be performed for each of the input questions, to generate a number of customized APT contracts that is equal to the number of input questions. Then at optional step 628 any duplicate customized APT contract may be discarded. If a first customized APT contract (generated to address a first input question) and a second customized APT contract (generated to address a second input question) are both based on the same generic APT contract and both have identical mapping between placeholders and parameters, one of the two customized APT contracts is a duplicate that can be discarded (e.g., arbitrarily discard the first or the second customized APT contract). After discarding the duplicate customized APT contract, the remaining customized APT contract is uniquely able to address both the first and second input questions.

Reference is now made to FIG. 6C, showing example steps for performing step 610. For ease of understanding, FIG. 6C will be discussed with respect to generating customized APT code for one customized APT contract.

Optionally, at 642, the customized APT contract may be obtained. In some examples, the customized APT contract, after being generated at step 608, may be stored before being obtained at step 610. In other examples, the customized APT contract may be used at step 610 immediately following generation at step 608, without a need for the customized APT contract to be obtained.

At 644, generic APT code corresponding to the generic APT contract that was the basis of the customized APT contract is obtained. The generic APT code provides the implementation of the generic function defined by the generic APT contract. The generic APT code may be generic in the sense that placeholders are used in place of specific variable names, and may not include code for constraints and/or metrics. However, the generic APT code may include OR engine endpoints that are required to carry out the generic function (e.g., calls to an OR solver).

In some examples, the generic APT code may be obtained at step 624 when the generic APT contract was retrieved (e.g., the generic APT code may be retrieved together with the generic APT contract by the APT contract generator 200 and may be provided to the APT implementor 300 with the customized APT contract). In some examples, the customized APT contract may identify the generic APT code to be retrieved from a database.

At 646, the generic APT code is customized by mapping parameters in the data schema to placeholders in the generic APT code. The mapping at step 646 may use the same mapping that was already performed at step 626, so that the mapping does not need to be generated using a NER model or LLM.

Optionally, at 648, if the generic APT code includes a placeholder code section (e.g., there may be a placeholder code section where a constraint definition or a metric definition should be added), a code snippet to replace the placeholder code section may be generated. In some examples, a LLM that has been fine-tuned to generate appropriate code may be used, as discussed above.

At 650, the customized APT code is deployed (e.g., deployed to a cloud-based system) to obtain the executable customized APT.

Reference is now made to FIG. 6D, showing example steps for performing step 612. For ease of understanding, FIG. 6C will be discussed with respect to verifying one customized APT.

Optionally, at 662, the customized APT contract may be obtained. In some examples, the customized APT contract may be stored before being obtained at step 662. In other examples, the customized APT contract may be used at step 662 without a need for the customized APT contract to be obtained. The customized APT contract defines the input parameters that may be used to execute the customized APT (e.g., by calling the deployed customized APT via an APT endpoint).

At 664, one or more test inputs are automatically generated based on the definitions of each input parameter provided in the data schema, as described above. For example, if an input parameter has a defined set of discrete values, test inputs may be generated for each of the possible values for that input parameter. In another example, if an input parameter has a defined range of numerical values, test inputs may be generated that sample values within the defined range.

At 666, one or more test executions of the customized APT are automatically performed using the one or more test inputs. This may be carried out by cycling through all of the generated test inputs one by one and calling the customized APT using each test input.

Optionally, at 668, an error may be received. A re-generation of the customized APT code may be requested. If an error is received and re-generation of the customized APT code is required, the method may return to step 610 without performing optional steps 670 or 672. Any error information that is received may be provided as input for the re-generation of the customized APT code.

Optionally, one or more outputs resulting from test executions of the customized APT using the one or more test inputs are collected. Sensitivity analysis may be performed on the collected output(s). For example, test executions of the customized APT may be performed in which a certain input parameter is varied while all other parameters are fixed. Then the resulting outputs may be collected and a standard deviation of the output values may be calculated. A larger standard deviation may indicate that the output is more sensitive to that certain input parameter, while a smaller standard deviation may indicate that the output is less sensitive to that certain input parameter. In some examples, a sensitivity plot may be generated as part of the sensitivity analysis.

Optionally, the test input(s) and corresponding output(s) may be added to the customized APT contract. Any sensitivity analysis that was performed may also be added to the customized APT contract.

In some examples, a UI (e.g., a GUI) may be provided to enable the user to interact with the APT generation system 100 and the APT generation method 600, such as to provide user input and view generated output. The UI may be part of an APT generation service that may be accessed by the user device 10 over a wireless network, for example, where the APT generation system 100 and the APT generation method 600 are provided as a cloud-based service or online service to a user. In some examples, the UI may be provided as a web-based portal that enables a user to interact with the APT generation system 100 over a wireless network.

An example UI is now described that receives user input, such as a list of input questions (and other required inputs) and generates a set of customized APTs that together address the list of input questions. In some examples, the UI may include a chatbot component that enables the user to provide inputs using natural language. In some examples, the APT generation system 100 may be provided as an end-to-end system that takes as input a list of questions and allows the user to use the deployed customized APTs as endpoints for a chatbot to call. It should be understood that other embodiments are possible within the scope of the present disclosure.

In some examples, the APT generation system 100 may be implemented as a tool generation application that allows a user to generate and deploy customized APTs, using operations as previously described. The user may only need to provide the input question(s) to be addressed, using natural language. This may improve the accessibility, transparency and efficiency of creating customized APTs to support the needs of the user or other operations planner. Each customized APT contains the customized APT contract and its customized APT code implementation. The customized APT contract may be used to create a detailed documentation for the customized APT, for example outlining the description, input parameters, along with some sample function calls and uses in its output schema and input/output examples. The user may be provided with the ability to revise the customized APT contract, and the APT generation system 100 may automatically update the customized APT code implementation accordingly, as discussed above.

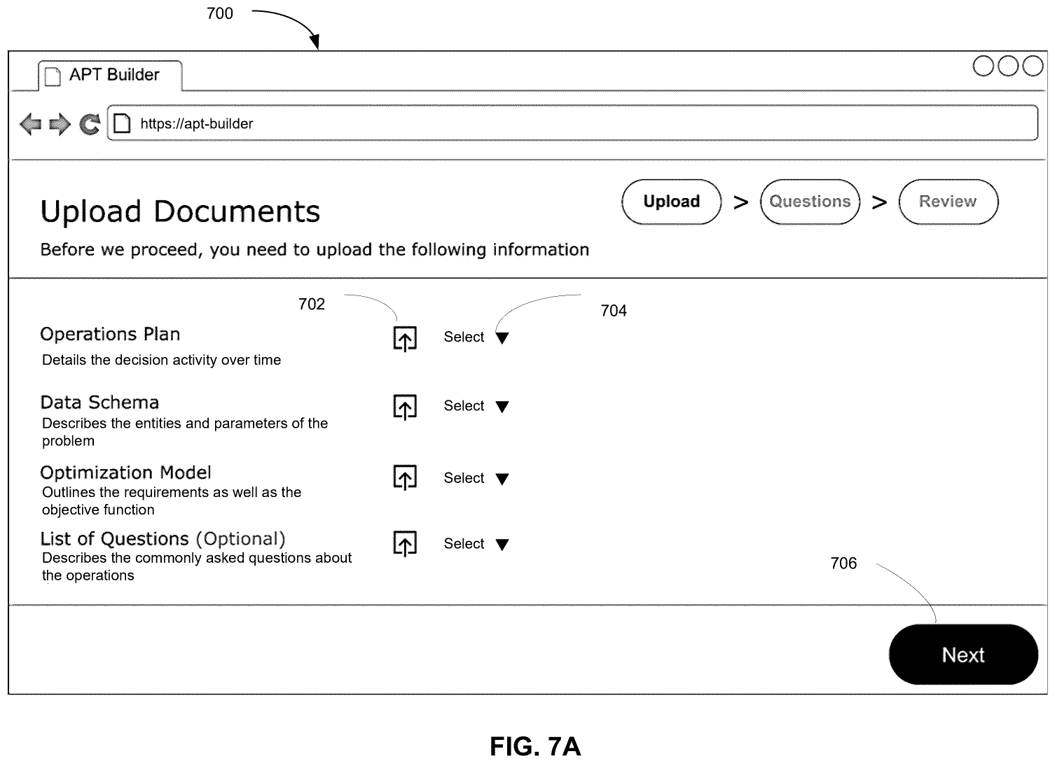

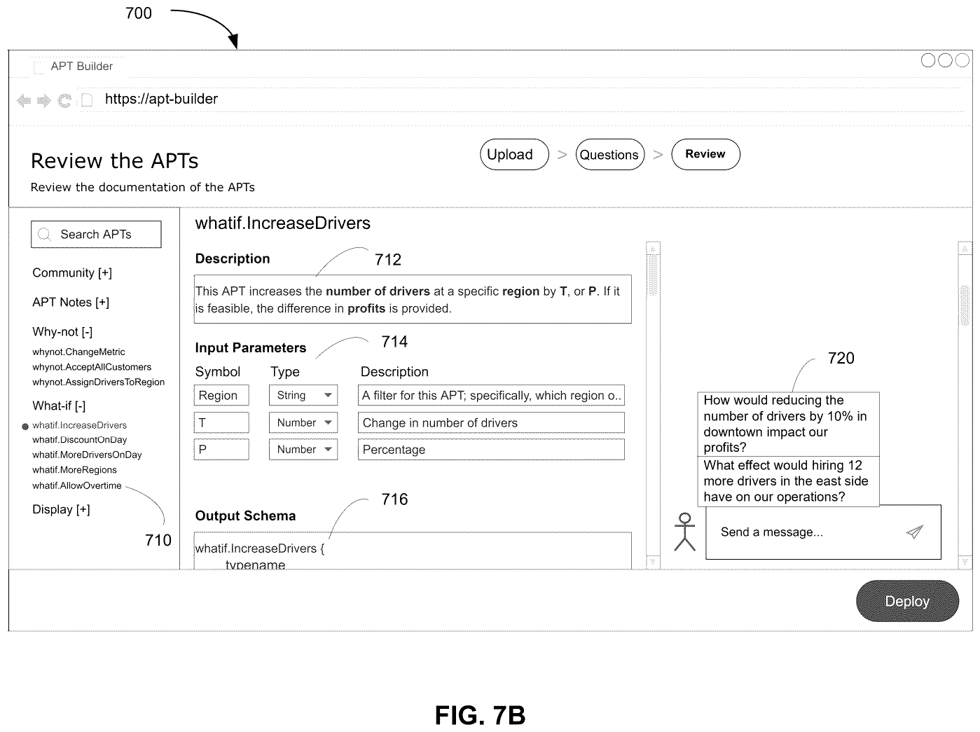

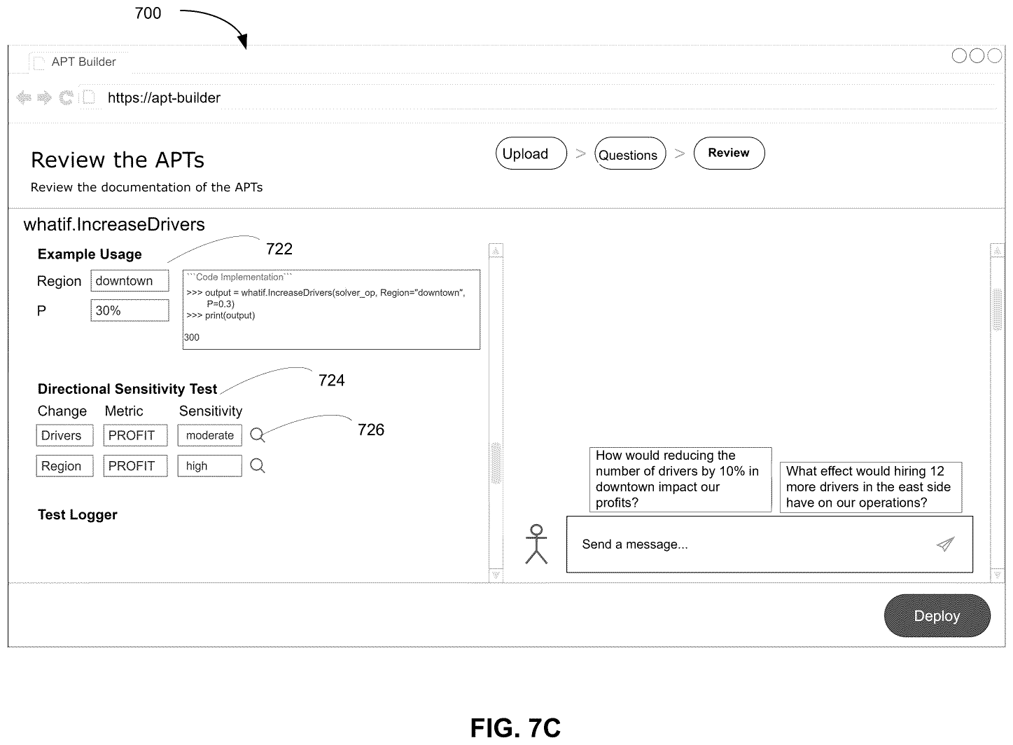

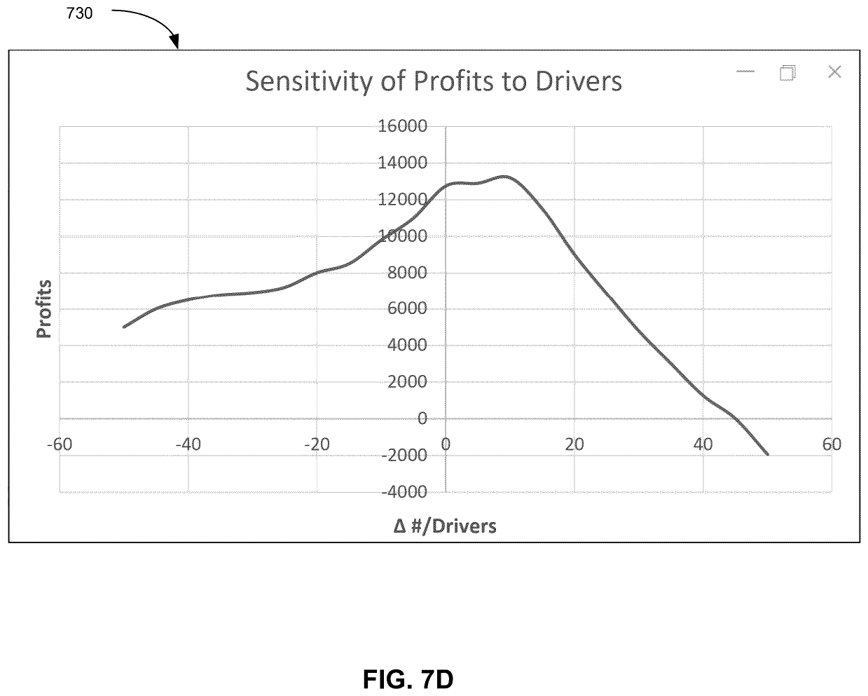

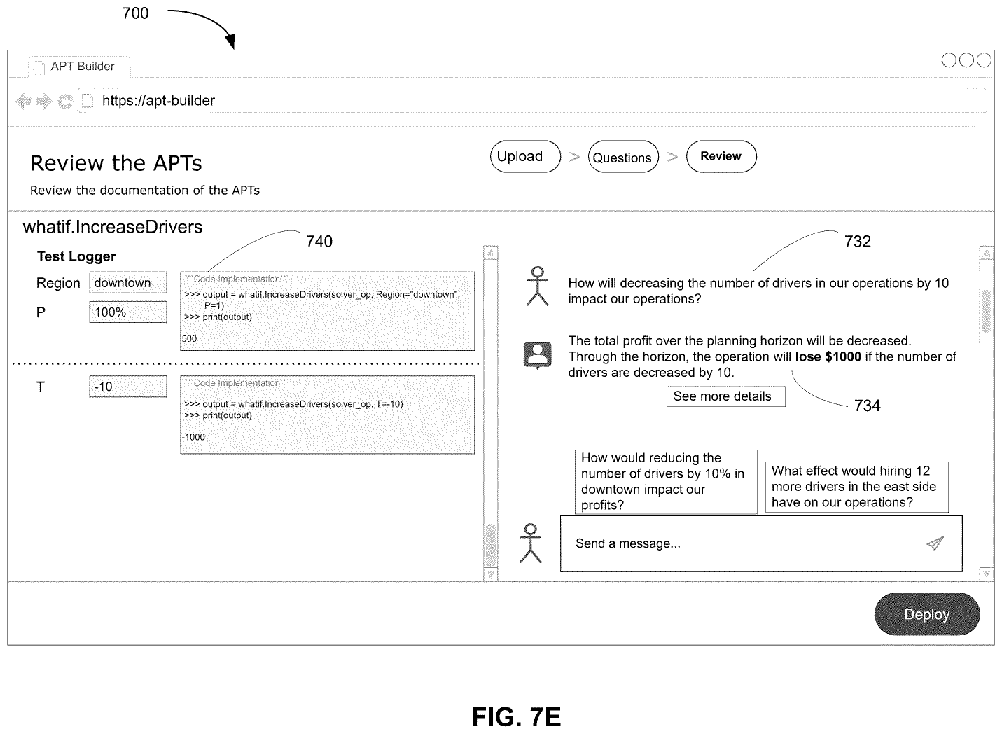

FIGS. 7A-7E show example screens of an example UI 700, which may be presented to a user interacting with the APT generation system 100 as disclosed herein. The example UI 700 may execute the APT generation system 100 without requiring the user to have detailed knowledge of the operations performed. The customized APT contract for a customized APT that is generated by the APT generation system 100 may be provided as output, to enable the user to view detailed documentation for understanding and verification of the customized APT. The user may, via the UI 700 (e.g., with assistance from a chatbot), revise the customized APT contract and/or include additional examples into the documentation. The UI 700 may also be used to call or execute the customized APT.

FIG. 7A shows an example screen of the UI 700, which may enable the user to provide inputs to the APT generation system 100, such as such as an operations plan, data schema, optimization model and a list of one or more questions. The UI 700 may enable the user to upload the inputs and/or to select from a list of options. For example, the UI 700 may include an option 702 for the user to upload an operations plan as well as an option 704 for the user to select an operations plan from a list (e.g., the list may include operations plans that have been previously uploaded or generated and that are stored in a memory accessible to the APT generation system 100). In this example, input of the list of questions may be optional. If the user does not provide a list of questions, a default list of questions (which may be a predefined list of questions that are common) may be automatically used as the basis for generating one or more customized APTs.

After user selection of the option 706 to proceed, a list of the questions may be presented for user confirmation and/or modification. If the user had provided a list of questions, the user-provided list of questions may be displayed. If the user did not provide a list of questions or selected to use the default list of questions, the default list of questions may be displayed. In some examples, the user may add to or revise the displayed list of questions, for example via a text input option provided by the UI 700.

Using the inputs provided, the APT generation system 100 may automatically generate one or more customized APTs to address the list of questions, for example using the method 600 described above.

FIG. 7B shows another example screen of the UI 700 that may be presented after the customized APT(s) have been generated. In this example, the UI 700 may be divided into three panels. A left panel includes an APT list 710 that is a comprehensive list of all customized APTs that have been generated, from which a user may select one customized APT to inspect. A middle panel provides information from the customized APT contract of the selected customized APT, such as the natural language description 712, input parameters 714 and output schema 716 defined by the customized APT contract. A right panel enables a user to carry out a chat session 720 with a chatbot, which may be used to interact with the selected customized APT (e.g., to execute the customized APT). For example, the user may provide inputs that change the values of various input parameters, the chatbot may call the customized APT (e.g., via the deployed APT endpoint) using the input values provided by the user, and the chatbot may present the resulting output from the customized APT in the chat session 720.

In some examples, the information from the customized APT contract may be displayed in editable form. The user may directly edit the fields 712, 714, 716, which may require the customized APT to be re-implemented. For example, after the user edits the customized APT contract, the edited customized APT contract may be processed by the APT implementor 300, as discussed previously, to generate new customized APT code in order to re-implement the customized APT.

In some examples, the example screen of FIG. 7B may be presented to the user after the customized APT contract has been generated but prior to generation of the customized APT code. This may enable the user to confirm that the customized APT contract correctly reflects the user's question and/or to make edits to the customized APT contract, prior to generation of the customized APT code.

In some examples, instead of providing a chat session 720 with a chatbot, the UI 700 may provide other ways for the user to interact with the selected customized APT, for example by providing a command line interface for the user to enter commands, by providing selectable soft buttons, etc.

FIG. 7C shows another example screen of the UI 700 in which the middle panel has been scrolled down to show more information from the customized APT contract of the selected customized APT. In this example, the left panel containing the APT list 710 has been hidden or minimized. In this example, an example usage 722 is presented, which indicates possible input parameters as well as the corresponding code implementation. Sensitivity test results 724 may also be presented, indicating sensitivity of certain outputs to certain inputs. Each sensitivity test result 724 may include an option 726 to view a plot of the sensitivity of an output metric as a function of the input parameter.

FIG. 7D shows an example pop-up window 730 that may be presented when the option 726 is selected. In this example, the pop-up window 730 shows a plot illustrating sensitivity of the metric “Profits” to the input parameter “T” indicating change in number of drivers.

FIG. 7E shows another example screen of the UI 700 illustrating how a user may interact with the customized APT using the chat session 720. The middle panel has been scrolled down to show more may display a test log 740 in which tests inputs and resulting outputs may be logged.

In this example, the chat session 720 shows that the user has provided input 732 that tests a possible change to the input parameters (e.g., decrease number of drivers by 10). This input is recognized by the chatbot as a change to the input parameter “T” by amount of −10, and is logged in the test log 740. The chatbot automatically calls the customized APT and provides a response 734 indicating the change in output (e.g., resulting decrease in profits) as a response of the changed input parameter. The code that was called may also be displayed in the test log 740. In this way, the user is provided with detailed documentation of tests carried out and may inspect the corresponding code.

In another example, a user may interact with the APT generation system 100 entirely via a chatbot instead of the UI 700. A chatbot may, for example, be used by an OR consultant to answer a client's questions more efficiently and with more supporting evidence and details, thereby increasing the consultant's efficiency and effectiveness. A chatbot may also be used by an operations planner to explore operations of their business, thus reducing the workload of the OR consultant and giving more control to the planner.

A chatbot may use the customized APT contract generated by the APT generator system 100 as input to the LLM, to provide context to more accurately identify the correct customized APT to use to perform a task requested by a user. For example, a user's question inputted to the chat session may be encoded into a question embedding that is used to search APT contract embeddings (which may encode information from corresponding APT contracts), in order to identify a most relevant APT to answer the user's question. The customized APT contract also defines the input parameters that are required to call the corresponding customized APT. This information may be passed to the chatbot system in a parameter extraction step where the required parameters are extracted from the chat history. The chatbot may then call the customized APT using the input parameters, and generate output to be displayed in the chat session.

For example, each time the user starts a new conversation or thread in the conversation, the chatbot may process the user's message to identify the intent of the user (e.g., is the user starting a new conversation thread, continuing the current conversation thread, discussing irrelevant matters or trying to perform a task (such as calling an APT)). The chat session may provide output to the user indicating the identified intent, so that the user can determine whether their intent was accurately recognized by the chatbot.

When the user is requesting a task that requires the use of an APT, the chatbot may detect the relevant customized APT to call (e.g., by performing an embedding-based search of available APT contracts, as discussed above). The chatbot may then extract the required input parameters from the chat history and/or current user query, execute the customized APT and obtain the output. The output may be processed using a response-rendering module (e.g., to render the output in natural language) before being presented to the user via the chat session.

It should be understood that such a chatbot as described above may be implemented as part of the UI 700 as well, in which case the user may not need to select a particular customized APT from an APT list (although this may still be an option).

Although an example UI 700 and chatbot have been illustrated and described, it should be understood that these examples are not intended to be limiting. For example, the APT generation system 100 and/or the APT generation method 600 may be provided with or without any UI or chatbot support. Additionally or alternatively, any UI or chatbot that supports natural language textual inputs from a user may be suitable for examples of the present disclosure.

In various examples, the present disclosure describes methods and systems for adopting and customizing an APS for a real-world business through the automated generation of customized APTs. Examples of the present disclosure may enable non-experts (e.g., other than support consultants and OR experts) to generate and modified APTs with greater reliability and transparency. The customized APT that is automatically generated may be able to call OR engine endpoints accurately and reliably. The generated customized APT may be automatically verified to ensure it is compilable and executable for all possible input values, thus reducing the chance of an unexpected error when used by a user.

Examples of the present disclosure may avoid the need for a human expert to manually manipulate the model or data in order to perform tests such as sensitivity testing. This may provide advantages in increased efficiency and reduced costs. Code implementation may also be automated, thus greatly reducing the burden on a human expert. Examples of the present disclosure may also automatically generate documentation, including example inputs/outputs and/or sensitivity analysis, which may enable a user who understands the business operations (but not necessarily the code) to perform common-sense verification of the generated customized APT. This avoids the need for tedious manual generation of sensitivity tests.

Examples of the present disclosure enable customized APTs to be generated based on natural language input questions, which avoids the need for the user to understand coding. At the same time, customized APTs are generated based on generic APTs that provide a reliable framework for code implementation. Further, a user may revise a generated customized APT through intuitive interaction with the customized APT contract, rather than manually updating the code (which can be tedious and error-prone).

Examples of the present disclosure may be provided as software applications and/or online services, includes websites, mobile applications or consultation services, among other examples.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computing system comprising:
a processing device configured to execute computer-readable instructions to cause the system to:
receive a set of one or more input questions for an operations plan, the operations plan being associated with a data schema and an optimization model;
generate a customized advanced planning tool (APT) providing a customized function to enable an advanced planning system (APS) to address at least a given one of the one or more input questions by:
retrieving, from a database, a generic APT contract defining one or more input parameters and an output schema for a generic function that is relevant to the given one input question;
customizing the generic APT contract by mapping parameters defined in the data schema to placeholders in the generic APT contract to obtain a customized APT contract defining one or more customized input parameters and a customized output schema for the customized APT;
obtain generic APT code corresponding to the generic APT contract, the generic APT code providing an implementation of the generic function;
customizing the generic APT code by replacing placeholders in the generic APT code with parameters defined in the data schema, in accordance with the mapping, to obtain customized APT code providing the customized function of the customized APT, and deploying the customized APT code to obtain the executable customized APT; and
performing verification of the customized APT by automatically performing test executions of the customized APT using one or more test inputs automatically generated using the data schema; and
output the customized APT contract to a user device and store the executable customized APT.

2. The computing system of claim 1, wherein the processing device is configured to execute computer-readable instructions to cause the system to:
receive, from the user device, natural language input providing the set of one or more input questions, code representing the optimization model and a data object representing the data schema.

3. The computing system of claim 1, wherein the processing device is configured to execute computer-readable instructions to cause the system to retrieve the generic APT contract by:
obtaining a question embedding encoded from the given one input question; and
retrieving, from the database, the generic APT contract corresponding to a contract embedding that is similar to the question embedding.

4. The computing system of claim 1, wherein the processing device is configured to execute computer-readable instructions to cause the system to:
generate a first customized APT contract to address a first question of the one or more input questions;
generate a second customized APT contract to address a second question of the one or more input questions, the first and second customized APT contracts being based on a common generic APT contract;
prior to obtaining customized APT code based on the first or second customized APT contracts, determine that the first and second customized APT contracts have identical mapping between parameters in the data schema and placeholders in the common generic APT contract; and
discard one of the first or second customized APT contracts, wherein customized APT code is only obtained for a remaining one of the first or second customized APT contracts.

5. The computing system of claim 1, wherein the processing device is configured to execute computer-readable instructions to cause the system to customize the generic APT code by:
generating a code snippet to replace a placeholder code section in the generic APT code.

6. The computing system of claim 5, wherein the processing device is configured to execute computer-readable instructions to cause the system to generate the code snippet by:
generating a prompt to a large language model (LLM) to perform a code generation task, the prompt including code representing the optimization model, the operations plan, the customized APT contract and at least a portion of the generic APT code including the placeholder code section; and
obtaining the generated code snippet as output from the LLM.

7. The computing system of claim 5, wherein the processing device is configured to execute computer-readable instructions to cause the system to:
receive an error during a particular test execution of the customized APT; and
re-generate at least the code snippet using information from the received error.

8. The computing system of claim 1, wherein the processing device is configured to execute computer-readable instructions to cause the system to perform verification of the customized APT by:
automatically generating the one or more test inputs, wherein the one or more test inputs include all possible values for a discrete input parameter defined in the data schema or include sample values within a numerical range defined for a numerical input parameter in the data schema.

9. The computing system of claim 1, wherein the processing device is configured to execute computer-readable instructions to cause the system to perform verification of the customized APT by:
collecting one or more outputs generated by the test executions of the customized APT; and
performing sensitivity analysis on the collected one or more outputs.

10. The computing system of claim 1, wherein the processing device is configured to execute computer-readable instructions to cause the system to:
include the one or more test inputs and corresponding outputs generated by the test executions of the customized APT in the customized APT contract.

11. The computing system of claim 1, wherein the processing device is configured to execute computer-readable instructions to cause the system to:
receive, from the user device, input revising the customized APT contract;
wherein the customized APT code is obtained in accordance with the revised customized APT contract.

12. A method for generating a customized advanced planning tool (APT) for an advanced planning system (APS), the method comprising:
receiving a set of one or more input questions for an operations plan, the operations plan being associated with a data schema and an optimization model;
generating the customized APT providing a customized function to address at least a given one of the one or more input questions by:
retrieving, from a database, a generic APT contract defining one or more input parameters and an output schema for a generic function that is relevant to the given one input question;
customizing the generic APT contract by mapping parameters defined in the data schema to placeholders in the generic APT contract to obtain a customized APT contract defining one or more customized input parameters and a customized output schema for the customized APT;
obtain generic APT code corresponding to the generic APT contract, the generic APT code providing an implementation of the generic function;
customizing the generic APT code by replacing placeholders in the generic APT code with parameters defined in the data schema, in accordance with the mapping, to obtain customized APT code providing the customized function of the customized APT, and deploying the customized APT code to obtain the executable customized APT; and
performing verification of the customized APT by automatically performing test executions of the customized APT using one or more test inputs automatically generated using the data schema; and
outputting the customized APT contract to a user device and storing the executable customized APT.

13. The method of claim 12, wherein retrieving the generic APT contract comprises:
obtaining a question embedding encoded from the given one input question; and
retrieving, from the database, the generic APT contract corresponding to a contract embedding that is similar to the question embedding.

14. The method of claim 12, further comprising:
generating a first customized APT contract to address a first question of the one or more input questions;
generating a second customized APT contract to address a second question of the one or more input questions, the first and second customized APT contracts being based on a common generic APT contract;
prior to obtaining customized APT code based on the first or second customized APT contracts, determining that the first and second customized APT contracts have identical mapping between parameters in the data schema and placeholders in the common generic APT contract; and
discarding one of the first or second customized APT contracts, wherein customized APT code is only obtained for a remaining one of the first or second customized APT contracts.

15. The method of claim 12, wherein customizing the generic APT code comprises:
generating a code snippet to replace a placeholder code section in the generic APT code by:
generating a prompt to a large language model (LLM) to perform a code generation task, the prompt including code representing the optimization model, the operations plan, the customized APT contract and at least a portion of the generic APT code including the placeholder code section; and
obtaining the generated code snippet as output from the LLM.

16. The method of claim 12, wherein performing verification of the customized APT comprises:
automatically generating the one or more test inputs, wherein the one or more test inputs include all possible values for a discrete input parameter defined in the data schema or include sample values within a numerical range defined for a numerical input parameter in the data schema.

17. The method of claim 12, wherein performing verification of the customized APT comprises:
collecting one or more outputs generated by the test executions of the customized APT; and
performing sensitivity analysis on the collected one or more outputs.

18. The method of claim 12, further comprising:
including the one or more test inputs and corresponding outputs generated by the test executions of the customized APT in the customized APT contract.

19. The method of claim 12, further comprising:
receiving, from the user device, input revising the customized APT contract;
wherein the customized APT code is obtained in accordance with the revised customized APT contract.

20. A non-transitory computer-readable medium having instructions stored thereon, wherein the instructions are executable by a processing device of a computing system to cause the computing system to:
receive a set of one or more input questions for an operations plan, the operations plan being associated with a data schema and an optimization model;
generate a customized advanced planning tool (APT) providing a customized function to enable an advanced planning system (APS) to address at least a given one of the one or more input questions by:
retrieving, from a database, a generic APT contract defining one or more input parameters and an output schema for a generic function that is relevant to the given one input question;
customizing the generic APT contract by mapping parameters defined in the data schema to placeholders in the generic APT contract to obtain a customized APT contract defining one or more customized input parameters and a customized output schema for the customized APT;
obtain generic APT code corresponding to the generic APT contract, the generic APT code providing an implementation of the generic function;
customizing the generic APT code by replacing placeholders in the generic APT code with parameters defined in the data schema, in accordance with the mapping, to obtain customized APT code providing the customized function of the customized APT, and deploying the customized APT code to obtain the executable customized APT; and
performing verification of the customized APT by automatically performing test executions of the customized APT using one or more test inputs automatically generated using the data schema; and
output the customized APT contract to a user device and store the executable customized APT.
